(19) United States
(12) Patent Application Publication
(10) Pub. No.: US 2016/0086386 A1
(43) Pub. Date: Mar. 24, 2016

(54) METHOD AND APPARATUS FOR SCREEN CAPTURE

(71) Applicant: Samsung Electronics Co., Ltd., Gyeonggi-do (KR)

(72) Inventors: Dong-Il SON, Gyeonggi-do (KR); Jung-Eun LEE, Gyeonggi-do (KR); Chi-Hyun CHO, Gyeonggi-do (KR); Woo-Jung HAN, Seoul (KR); Chang-Ryong HEO, Gyeonggi-do (KR); Woo-Sung CHOI, Gyeonggi-do (KR)

(21) Appl. No.: 14/855,522

(22) Filed: Sep. 16, 2015

(30) Foreign Application Priority Data
Sep. 19, 2014 (KR) 10-2014-0125049

(51) Int. Cl. G06T 19/20; H04N 13/00; H04N 5/232; G02B 27/22; G02B 27/01

(52) U.S. Cl. CPC G06T 19/20; G02B 27/22; G02B 27/017; H04N 5/23293; H04N 5/23229; H04N 13/0011; G02B 2027/0178

(57) ABSTRACT

An electronic device includes: a display; and at least one processor configured to: generate a virtual reality image to be applied to a virtual reality environment, generate a right eye image and a left eye image based on the virtual reality image, pre-distort the right eye image and the left eye image based on lens distortion, control the display to display a stereo image on the display by using the right eye image and the left eye image, and in response to detecting a capture event while the stereo image is displayed, generate a captured image by using the virtual reality image.

### CLAIM OF PRIORITY

This application claims priority under 35 U.S.C. §119(a) to Korean Application Serial No. 10-2014-0125049, which was filed in the Korean Intellectual Property Office on Sep. 19, 2014, the entire content of which is hereby incorporated by reference.

### TECHNICAL FIELD

The present disclosure relates to electronic devices, and more particularly to a method and apparatus for screen capture.

### BACKGROUND

Due to the development of information communication technologies and semiconductor technologies, various electronic devices have been developed as multimedia devices that provide various multimedia services. For example, portable electronic devices provide various multimedia services such as a broadcasting service, a wireless Internet service, a camera service, and a music reproduction service.

The electronic devices have evolved to a body-fitted type electronic device (for example, a Head-Mounted Display: HMD). For example, the HMD type electronic device is attached to a user's head to provide various functions to the user.

### SUMMARY

An HMD type electronic device may provide a user with a virtual environment service that gives a sense of space in a stereoscopic image (for example, 3D image) or a planar image. For example, the electronic device may display a right eye image and a left eye image corresponding to the user's eyes on a display.

The electronic device may provide a screenshot function for instantaneously capturing and storing an image displayed on the display in response to a user input. However, a general screenshot function corresponds to a function for capturing and storing an image displayed on the display in a mono display environment and requires a method of capturing a stereoscopic image displayed in the display in a stereo display environment.

Embodiments of the present disclosure may provide an apparatus and a method for capturing an image displayed on a display of an electronic device in a stereo display environment.

Embodiments of the present disclosure may provide an apparatus and a method for capturing information of a virtual reality environment recognized by a user of an electronic device in a stereo display environment.

According to aspects of the disclosure, an electronic device comprising: a display; and at least one processor configured to: generate a virtual reality image to be applied to a virtual reality environment, generate a right eye image and a left eye image based on the virtual reality image, pre-distort the right eye image and the left eye image based on lens distortion, control the display to display a stereo image on the display by using the right eye image and the left eye image, and in response to detecting a capture event while the stereo image is displayed, generate a captured image by using the virtual reality image.

According to aspects of the disclosure, an electronic device is provided comprising: a display; and at least one processor configured to: generate a virtual reality image to be applied to a virtual reality environment, generate a right eye image and a left eye image based on the virtual reality image, pre-distort the right eye image and the left eye image based on lens distortion, control the display to display a stereo image on the display by using the right eye image and left eye image, and in response to detecting a capture event while the stereo image is displayed, generate a captured image by using at least one of the right eye image and the left eye image.

According to aspects of the disclosure, an electronic device is provided comprising: a display configured to display a stereo image in a viewport within a virtual reality space; and at least one processor configured to capture information related to one or more images corresponding to one or more directions based on the viewport within the virtual reality space in response to a capture input.

According to aspects of the disclosure, a method is provided comprising: generating, by an electronic device, a virtual reality image to be applied to a virtual reality environment; generating a right eye image and a left eye image based on the virtual reality image; pre-distorting the right eye image and the left eye image based on lens distortion; displaying a stereo image by using the right eye image and left eye image; and in response to detecting a capture event while the stereo image is displayed, generating a captured image by using the virtual reality image.

According to aspects of the disclosure, a method is provided comprising: generating, by an electronic device, a virtual reality image to be applied to a virtual reality environment; generating a right eye image and a left eye image based on the virtual reality image; pre-distorting the right eye image and the left eye image based on lens distortion; displaying a stereo image by using the right eye image and left eye image; and in response to detecting a capture event while the stereo image is displayed, generating a captured image by using at least one of the right eye image and the left eye image.

### BRIEF DESCRIPTION OF THE DRAWINGS

The above and other aspects, features, and advantages of the present disclosure will be more apparent from the following detailed description taken in conjunction with the accompanying drawings, in which:

FIG. 1A is a diagram of an example of a Head-Mounted Display (HMD) device, according to aspects of the present disclosure;

FIG. 1B is a diagram of an example of a Head-Mounted Display (HMD) device, according to aspects of the present disclosure

FIG. 2 is a block diagram of an example of an electronic device, according to aspects of the present disclosure;

FIG. 3 is a block diagram of an example of a processor, according to aspects the present disclosure;

FIG. 4A is a diagram of an example of a screen configuration, according to aspects of the present disclosure;

FIG. 4B is a diagram of an example of a screen configuration, according to aspects of the present disclosure;

FIG. 4C is a diagram of an example of a screen configuration, according to aspects of the present disclosure;

FIG. 4D is a diagram of an example of a screen configuration, according to aspects of the present disclosure;

FIG. 4E is a diagram of an example of a screen configuration, according to aspects of the present disclosure;

FIG. 5A is a diagram of an example of a screen configuration for generating a stereo display, according to aspects of the disclosure;

FIG. 5B is a diagram of an example of a screen configuration for generating a stereo display, according to aspects of the disclosure;

FIG. 5C is a diagram of an example of a screen configuration for generating a stereo display, according to aspects of the disclosure;

FIG. 5D is a diagram of an example of a screen configuration for generating a stereo display, according to aspects of the disclosure;

FIG. 5E is a diagram of an example of a screen configuration for generating a stereo display, according to aspects of the disclosure;

FIG. 6 is a flowchart of an example of a process in which an electronic device generates a captured image by using a virtual reality image, according to aspects of the present disclosure;

FIG. 7 is a flowchart of an example of a process in which an electronic device generates a captured image by using binocular images, according to aspects of the present disclosure;

FIG. 8 is a flowchart of an example of a sub-process for generating a captured image by using the binocular images of FIG. 7, according to aspects of the disclosure;

FIG. 9 is a flowchart of another example of a sub-process for generating a captured image by using the binocular images of FIG. 7, according to aspects of the disclosure;

FIG. 10 is a flowchart of yet another example of a sub-process for generating a captured image by using the binocular images of FIG. 7, according to aspects of the disclosure;

FIG. 11A is a diagram of an example of a screen configuration for capturing information in a virtual reality environment, according to aspects of the disclosure;

FIG. 11B is a diagram of an example of a screen configuration for capturing information in a virtual reality environment, according to aspects of the disclosure;

FIG. 11C is a diagram of an example of a screen configuration for capturing information in a virtual reality environment, according to aspects of the disclosure;

FIG. 11D is a diagram of an example of a screen configuration for capturing information in a virtual reality environment, according to aspects of the disclosure;

FIG. 11E is a diagram of an example of a screen configuration for capturing information in a virtual reality environment, according to aspects of the disclosure;

FIG. 11F is a diagram of an example of a screen configuration for capturing information in a virtual reality environment, according to aspects of the disclosure;

FIG. 12A is a diagram of an example of a screen configuration for capturing information in a virtual reality environment, according to aspects of the disclosure;

FIG. 12B is a diagram of an example of a screen configuration for capturing information in a virtual reality environment, according to aspects of the disclosure;

FIG. 12C is a diagram of an example of a screen configuration for capturing information in a virtual reality environment, according to aspects of the disclosure;

FIG. 13A is a diagram of an example of an image format for sharing a captured image, according to aspects of the disclosure;

FIG. 13B is a diagram of an example of an image format for sharing a captured image, according to aspects of the disclosure;

FIG. 13C is a diagram of an example of an image format for sharing a captured image, according to aspects of the disclosure;

FIG. 13D is a diagram of an example of an image format for sharing a captured image, according to aspects of the disclosure;

FIG. 13E is a diagram of an example of an image format for sharing a captured image, according to aspects of the disclosure;

FIG. 14 is a flowchart of an example of a process, according to aspects of the disclosure;

FIG. 15 is a flowchart of an example of a process, according to aspects of the disclosure;

FIG. 16 is a flowchart of an example of a process, according to aspects of the disclosure;

FIG. 17 is a flowchart of an example of a process, according to aspects of the disclosure;

FIG. 18A is a diagram of an example of a screen configuration for displaying a captured image, according to aspects of the disclosure;

FIG. 18B is a diagram of an example of a screen configuration for displaying a captured image, according to aspects of the disclosure;

FIG. 19 is a block diagram of an example of an electronic device, according to aspects of the present disclosure.

### DETAILED DESCRIPTION

Hereinafter, various embodiments of the present disclosure will be described with reference to the accompanying drawings. In the following description, specific details such as detailed configuration and components are merely provided to assist the overall understanding of these embodiments. Therefore, it should be apparent to those skilled in the art that various changes and modifications of the embodiments described herein can be made without departing from the scope and spirit of the present disclosure. In addition, descriptions of well-known functions and constructions are omitted for clarity and conciseness.

The present disclosure may have various embodiments, and modifications and changes may be made therein. Therefore, the present disclosure will be described in detail with reference to particular embodiments shown in the accompanying drawings. However, it should be understood that the present disclosure is not limited to the particular embodiments, but includes all modifications/changes, equivalents, and/or alternatives falling within the spirit and the scope of the present disclosure. In describing the drawings, similar reference numerals may be used to designate similar elements.

The terms “have”, “may have”, “include”, or “may include” used in the various embodiments of the present disclosure indicate the presence of disclosed corresponding functions, operations, elements, and the like, and do not limit additional one or more functions, operations, elements, and the like. In addition, it should be understood that the terms “include” or “have” used in the various embodiments of the present disclosure are to indicate the presence of features, numbers, steps, operations, elements, parts, or a combination thereof described in the specifications, and do not preclude the presence or addition of one or more other features, numbers, steps, operations, elements, parts, or a combination thereof.

The terms “A or B”, “at least one of A or/and B” or “one or more of A or/and B” used in the various embodiments of the present disclosure include any and all combinations of words enumerated with it. For example, “A or B”, “at least one of A and B” or “at least one of A or B” means (1) including at least one A, (2) including at least one B, or (3) including both at least one A and at least one B.

Although the term such as “first” and “second” used in various embodiments of the present disclosure may modify various elements of various embodiments, these terms do not limit the corresponding elements. For example, these terms do not limit an order and/or importance of the corresponding elements. These terms may be used for the purpose of distinguishing one element from another element. For example, a first user device and a second user device all indicate user devices and may indicate different user devices. For example, a first element may be named a second element without departing from the scope of right of various embodiments of the present disclosure, and similarly, a second element may be named a first element.

It will be understood that when an element (e.g., first element) is “connected to” or “(operatively or communicatively) coupled with/to” to another element (e.g., second element), the element may be directly connected or coupled to another element, and there may be an intervening element (e.g., third element) between the element and another element. To the contrary, it will be understood that when an element (e.g., first element) is “directly connected” or “directly coupled” to another element (e.g., second element), there is no intervening element (e.g., third element) between the element and another element.

The expression “configured to (or set to)” used in various embodiments of the present disclosure may be replaced with “suitable for”, “having the capacity to”, “designed to”, “adapted to”, “made to”, or “capable of” according to a situation. The term “configured to (set to)” does not necessarily mean “specifically designed to” in a hardware level. Instead, the expression “apparatus configured to . . . ” may mean that the apparatus is “capable of . . . ” along with other devices or parts in a certain situation. For example, “a processor configured to (set to) perform A, B, and C” may be a dedicated processor, e.g., an embedded processor, for performing a corresponding operation, or a general-purpose processor, e.g., a Central Processing Unit (CPU) or an application processor (AP), capable of performing a corresponding operation by executing one or more software programs stored in a memory device.

The terms as used herein are used merely to describe certain embodiments and are not intended to limit the present disclosure. As used herein, singular forms may include plural forms as well unless the context explicitly indicates otherwise. Further, all the terms used herein, including technical and scientific terms, should be interpreted to have the same meanings as commonly understood by those skilled in the art to which the present disclosure pertains, and should not be interpreted to have ideal or excessively formal meanings unless explicitly defined in various embodiments of the present disclosure.

The module or programming module according to various embodiments of the present disclosure may further include at least one or more constitutional elements among the aforementioned constitutional elements, or may omit some of them, or may further include additional other constitutional elements. Operations performed by a module, programming module, or other constitutional elements according to various embodiments of the present disclosure may be executed in a sequential, parallel, repetitive, or heuristic manner. In addition, some of the operations may be executed in a different order or may be omitted, or other operations may be added.

An electronic device according to various embodiments of the present disclosure may be a device including a display function. For example, the electronic device according to various embodiments of the present disclosure may include at least one of: a smartphone; a tablet personal computer (PC); a mobile phone; a video phone; an e-book reader; a desktop PC; a laptop PC; a netbook computer; a workstation, a server, a personal digital assistant (PDA); a portable multimedia player (PMP); an MP3 player; a mobile medical device; a camera; or a wearable device (e.g., a head-mount-device (HMD), an electronic glasses, an electronic clothing, an electronic bracelet, an electronic necklace, an electronic appcessory, an electronic tattoo, a smart mirror, or a smart watch).

In other embodiments, an electronic device may be a smart home appliance including a display function. For example, of such appliances may include at least one of: a television (TV); a digital video disk (DVD) player; an audio component; a refrigerator; an air conditioner; a vacuum cleaner; an oven; a microwave oven; a washing machine; an air cleaner; a set-top box; a home automation control panel; a security control panel; a TV box (e.g., Samsung HomeSync®, Apple TV®, or Google TV); a game console (e.g., Xbox® PlayStation®); an electronic dictionary; an electronic key; a camcorder; or an electronic frame.

In other embodiments, an electronic device may include at least one of: a medical equipment (e.g., a mobile medical device (e.g., a blood glucose monitoring device, a heart rate monitor, a blood pressure monitoring device or a temperature meter), a magnetic resonance angiography (MRA) machine, a magnetic resonance imaging (MRI) machine, a computed tomography (CT) scanner, or an ultrasound machine); a navigation device; a global positioning system (GPS) receiver; an event data recorder (EDR); a flight data recorder (FDR); an in-vehicle infotainment device; an electronic equipment for a ship (e.g., ship navigation equipment and/or a gyrocompass); an avionics equipment; a security equipment; a head unit for vehicle; an industrial or home robot; an automatic teller's machine (ATM) of a financial institution, point of sale (POS) device at a retail store, or an internet of things device (e.g., a Lightbulb, various sensors, an electronic meter, a gas meter, a sprinkler, a fire alarm, a thermostat, a streetlamp, a toaster, a sporting equipment, a hot-water tank, a heater, or a boiler and the like)

In certain embodiments, an electronic device may include at least one of: a piece of furniture or a building/structure; an electronic board; an electronic signature receiving device; a projector; and various measuring instruments (e.g., a water meter, an electricity meter, a gas meter, or a wave meter), each of which includes a display function.

An electronic device according to various embodiments of the present disclosure may also include a combination of one or more of the above-mentioned devices.

Further, it will be apparent to those skilled in the art that an electronic device according to various embodiments of the present disclosure is not limited to the above-mentioned devices.

Herein, the term “user” may indicate a person who uses an electronic device or a device (e.g., an artificial intelligence electronic device) that uses the electronic device.

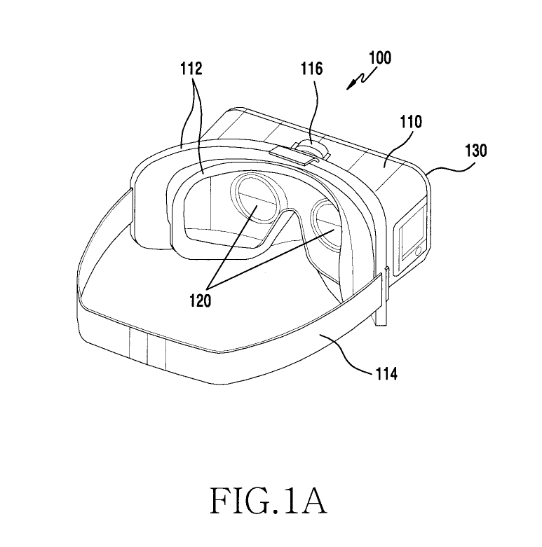

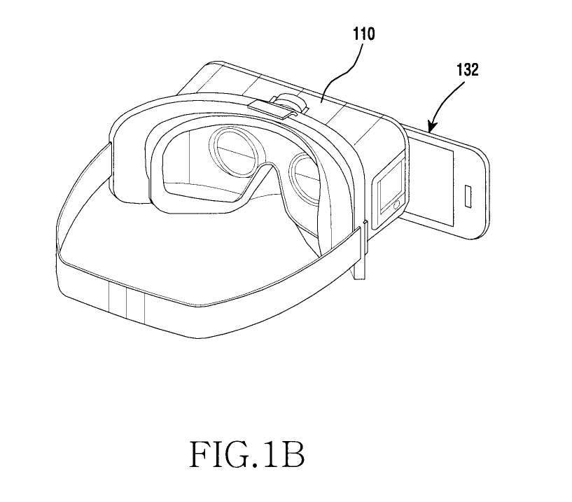

Hereinafter, various embodiments of the present disclosure are related to a technology for capturing a screen displayed on a display of an electronic device in a stereo display environment. According to an embodiment, the electronic device in the stereo display environment may include a Head-Mounted Display (HMD) type electronic device as illustrated in FIG. 1A or 1B.

FIGS. 1A and 1B illustrate a configuration of an HMD device according to aspects of the present disclosure.

Referring to FIG. 1A, an HMD device 100 may include a frame 110, a wearable part 112, a band part 114, an optical unit 120, and a display 130.

The frame 110 may functionally or physically connect components of the HMD device 100 (for example, the optical unit 120, the display 130, and at least one control module (not shown)). For example, at least some areas of the frame 110 may be formed in a curved structure based on a facial shape to be worn on the user's face.

According to an embodiment, the frame 110 may include a focus adjustable module (adjustable optics) 116 for adjusting the focus of the display 130 by the user. For example, the focus adjustable module 116 may adjust the user's focus by controlling at least one of a position of a lens or a position of the display 130 to allow the user to view an image appropriate for user's sight.

The wearable part 112 may contact a part of the user's body. For example, the wearable part 112 may make the frame 110 fit around user's eyes by using an elastic band.

The band part 114 may be formed of an elastic material such as a rubber material and may be coupled at the back of the user's head through a hook formed at the end of the band part 114.

The optical unit 120 may be configured to allow the user to identify an image displayed on the display 130. For example, the optical unit 120 may include lenses, a barrel, and an aperture to allow the user to identify an image displayed on the display 130.

The display 130 may display various pieces of information (for example, multimedia data, text data, and the like) for the user. For example, the display 130 may display a right eye image and a left eye image corresponding to the user's eyes to allow the user to feel a 3D effect.

According to various embodiments, although not illustrated, the frame 110 of the HMD device 100 may include a sensor module.

The sensor module may convert information on a measured physical quantity of the HMD device 100 or operational state information of the HMD device 100 into an electrical signal. According to an embodiment, the sensor module may include at least one of an acceleration sensor, a gyro sensor, and a geomagnetic sensor to detect a motion of the user's head wearing the HMD device 100. According to an embodiment, the sensor module may include at least one of a proximity sensor and a grip sensor to detect whether the user wears the HMD device 100.

Referring to FIG. 1B, the HMD device 100 may be functionally connected to an electronic device 132 and thus use the electronic device 132 as the display 130.

When the electronic device 132 is used as the display 130 of the HMD device 100, the frame 110 may include a docking space to which the electronic device 132 can be connected. For example, the frame 110 may use an elastic material or include a docking space having a structurally variable size, and thus connect the electronic device 132 to the HMD device 100 regardless of the size of the electronic device 132.

According to various embodiments, the HMD device 100 may be connected to the electronic device 132 mounted to the docking space of the frame 110 through a USB or wired communication performing a similar function to that of the USB or wireless communication such as wireless LAN (for example, WiFi or WiFi direct) or Bluetooth.

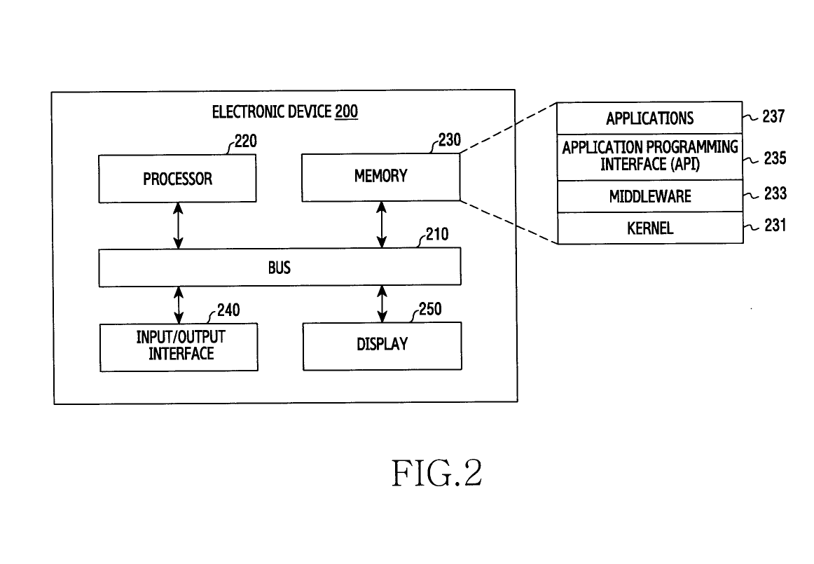

FIG. 2 is a block diagram of an example of an electronic device, according to aspects of the present disclosure. In the following description, an electronic device 200 may be the HMD device 100 of FIG. 1 or the electronic device 132, which is functionally connected to the HMD device 100.

Referring to FIG. 2, the electronic device 200 may include a bus 210, a processor 220, a memory 230, an input/output interface 240, and a display 250.

The bus 210 may include a circuit that connects the above-described components (for example, the processor 220, the memory 230, the input/output interface 240, or the display 250) and transmits communication (for example, control messages) between the above-described components.

The processor 220 may include any suitable type of processing circuitry. For example, the processor may include any combination of: one or more general-purpose processors (e.g., ARM-based processors, multi-core processors, etc.), a Field-Programmable Gate Array (FPGA), an Application-Specific Integrated Circuit (ASIC), a Digital Signal Processor (DSP), a Programmable Logic Device (PLD), etc. In operation, the processor 220 may receive commands from the above-described other components (for example, the memory 230, the input/output interface 240, or the display 250) through the bus 210, interpret the received commands, and perform calculations or data processing according to the interpreted commands.

According to an embodiment, the processor 220 may generate a virtual reality image mapped to a virtual reality environment by using an image to be displayed on the display 250 or data related to the image. The processor 220 may generate a right eye image and a left eye image corresponding to the user's eyes by using the virtual reality image. The processor 220 may pre-distort the right eye image and the left eye image in accordance with lens distortion and provide the pre-distorted images to the display 250 in order to allow the user to recognize non-distorted images through lenses of the optical unit 120. For example, the processor 220 may generate a virtual reality image by using data stored in the memory 230, data provided from the server, or data provided from an external electronic device.

According to an embodiment, the processor 220 may transform an image displayed on the display 250 in accordance with a motion of the electronic device 200 and provide the transformed image to the display 250.

According to an embodiment, when an input for capturing a screen is detected while a virtual reality service is provided, the processor 220 may generate a captured image corresponding to the screen displayed on the display 250 by using the virtual reality image.

According to an embodiment, when an input for capturing a screen is detected while a virtual reality service is provided, the processor 220 may select one of the right eye image and the left eye image as a captured image corresponding to the screen displayed on the display 250.

According to an embodiment, when an input for capturing a screen is detected while a virtual reality service is provided, the processor 220 may estimate an intermediate viewpoint based on the user's right eye and left eye. The processor 220 may generate an image corresponding to the intermediate viewpoint by using the virtual reality image. The processor 220 may determine the image corresponding to the intermediate viewpoint as the captured image corresponding to the screen displayed on the display 250.

According to an embodiment, when an input for capturing a screen is detected while a virtual reality service is provided, the processor 220 may combine the right eye image and the left eye image and generate a stereoscopic image depicting one or more objects included in the image. For example, the processor 220 may generate a stereoscopic image expressing a stereoscopic effect (for example, depth) of one or more objects included in the image. The processor 220 may identify the stereoscopic image as the captured image corresponding to the screen displayed on the display 250.

According to an embodiment, when an input for capturing a screen is detected while a virtual reality service is provided, the processor 220 may generate image information in one or more directions based on a viewport. The processor 220 may generate the captured image corresponding to the screen currently displayed on the display 250 by using image information in each direction. The viewport may refer to an area of image information provided at the user's line of sight in the virtual reality service.

The memory 230 may include any suitable type of volatile and non-volatile memory, such as Random-Access Memory (RAM), a Solid-State Drive (SSD), a network-accessible storage device (NAS), a cloud storage, a Read-Only Memory (ROM), a flash memory, etc. The memory 230 may store commands or data received from or generated by the processor 220 or other components (for example, the input/output interface 240 or the display 250). For example, the memory 230 may store data to be reproduced by the electronic device 200 for the virtual reality service.

According to an embodiment, the memory 230 may store a captured image, which is captured by the processor 220. For example, the memory 230 may separately store a mono image and a stereo image by using logically or physically separated memory areas. Accordingly, the processor 220 may separately operate a general capture and a capture for the virtual reality service.

According to an embodiment, the memory 230 may include programming modules such as a kernel 231, middleware 233, an Application Programming Interface (API) 235, or applications 237 (for example, application program). Each of the above-described programming modules 231, 233, 235, or 237 may be implemented by software, firmware, hardware, or a combination of two or more thereof.

The kernel 231 may control or manage system resources (for example, the bus 210, the processor 220, or the memory 230) used for executing an operation or function implemented by the remaining programming modules (for example, the middleware 233, the API 235, or the applications 237). The kernel 231 may provide an interface by which the middleware 233, the API 235, or the application 237 may access an individual component of the electronic device 200 to control or manage the component.

The middleware 233 may serve as a relay so that the API 235 or the applications 237 communicate to exchange data with the kernel 231. The middleware 233 may control task requests received from the applications 237. For example, the middleware 233 may control (for example, schedule or load-balance) task requests by using a method of assigning priorities, by which the system resources of the electronic device 200 can be first used, to at least one of the applications 237.

The API 235 is an interface by which the applications 237 control functions provided from the kernel 231 or the middleware 232, and may include a function (for example, command). For example, the API 235 may include at least one interface for file control, window control, image processing, or text control.

According to the various embodiments, the applications 237 may include a Short Message Service (SMS)/Multimedia Message Service (MMS) application, an e-mail application, a calendar application, an alarm application, a health care application (for example, an application for measuring a work rate or a blood sugar), an environment information application (for example, an application for providing atmospheric pressure, humidity, or temperature information). The applications 237 may be an application related to an information exchange between the electronic device 200 and an external electronic device. For example, the application related to the information exchange may include a notification relay application for transferring particular information (for example, notification information) to the external electronic device or a device management application for managing the external electronic device.

For example, the notification relay application may have a function of transmitting notification information generated by other application programs of the electronic device 200 (for example, the SMS/MMS application, the e-mail application, the health care application, or the environment information application) to the external electronic device. For example, the notification relay application may receive notification information from the external electronic device and provide the received notification information to the user. For example, the device management application may manage (for example, install, delete, or update) a function for at least some parts of the external electronic device (for example, the electronic device 104) communicating with the electronic device 200 (for example, a function of turning on/off the external electronic device itself (or some components) or a function of adjusting luminance (or a resolution) of the display), applications operating in the external electronic device, or services provided by the external electronic device (for example, a call service and a message service).

The input/output interface 240 may transmit commands or data input from the user through an input/output device (for example, a sensor, a keyboard, or a touch screen) to the above-described other components (for example, the processor 220, the memory 230, or the display 250). For example, the input/output interface 240 may provide the processor 220 with data on a user's touch input through the touch screen. Further, through an input/output device (for example, speaker or display), the input/output interface 240 may output commands or data, received from the processor 220 or the memory 230 through the bus 210. For example, the input/output interface 240 may output voice data processed through the processor 220 to the user through a speaker.

The display 250 may display various pieces of information (for example, multimedia data, text data, and the like) for the user. For example, the display 250 may perform a stereo display function of displaying a pre-distorted right eye image and left eye image provided from the processor 220 to allow the user to feel the stereoscopic effect.

The display 250 may include a display panel including a plurality of pixels arranged therein such as a Liquid Crystal Display (LCD), a Plasma Display Panel (PDP), or an Organic Light Emitting Diode (OLED), and a Display Driver IC (DDI) for driving the display panel.

The display 250 may be implemented to have the same size as an entire size of a one-way mirror or a half mirror or have the same size as a size of at least a part of the one-way mirror or the half mirror, and the number of displays may be one or more. Further, the display 250 may provide a partial display function of activating only a specific pixel area.

Although not illustrated, the electronic device 200 may include a communication interface for communicating with an external device (for example, the external electronic device or the server). For example, the communication interface may be connected to a network through wireless communication or wired communication, and may communicate with an external device. For example, the electronic device 200 may transmit a captured image generated through the processor 220 to the server or the external electronic device through the communication interface.

According to an embodiment, the wireless communication may include at least one of, for example, Wi-Fi, Bluetooth (BT), Near Field Communication (NFC), Global Positioning System (GPS) and cellular communication (for example LTE, LTE-A, CDMA, WCDMA, UMTS, WiBro, GSM, etc.). Also, the wired communication may include at least one of, for example, a Universal Serial Bus (USB), a High Definition Multimedia Interface (HDMI), Recommended Standard 232 (RS-232), and a Plain Old Telephone Service (POTS).

According to an embodiment, the network may be a communication network. For example, the communication network may include at least one of a computer network, the Internet, the Internet of Things, and a telephone network.

According to an embodiment, a protocol (for example, a transport layer protocol, data link layer protocol, or a physical layer protocol) for communication between the electronic device 200 and the external device may be supported by at least one of the applications 237, the API 235, the middleware 234, the kernel 231, and the communication interface.

According to an embodiment, the server may support driving of the electronic device 200 by conducting at least one of the operations (or functions) implemented by the electronic device 200.

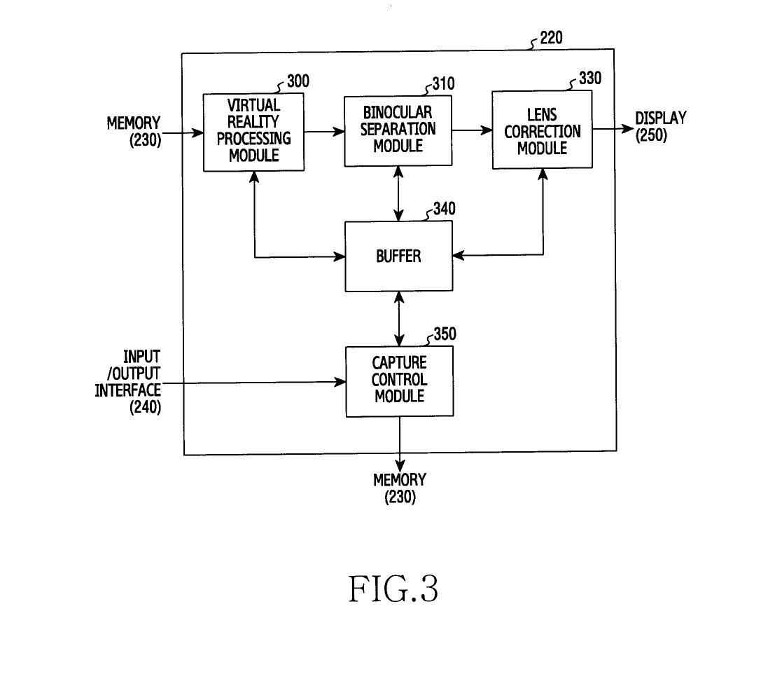

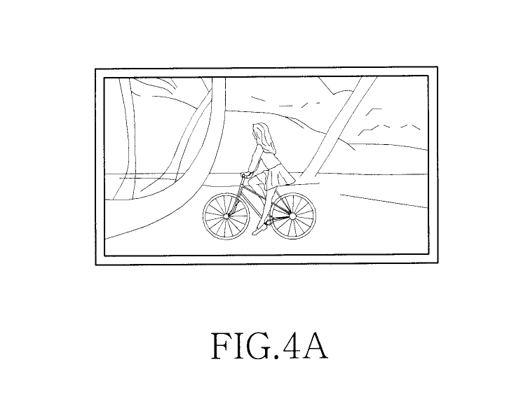

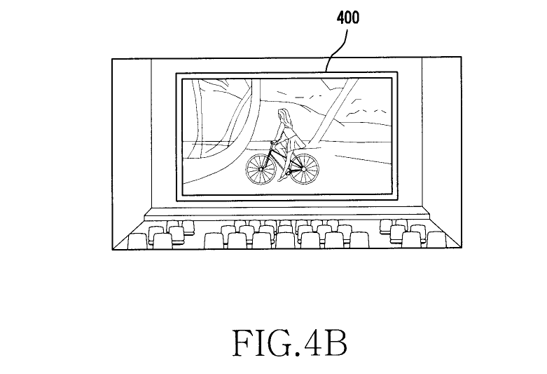

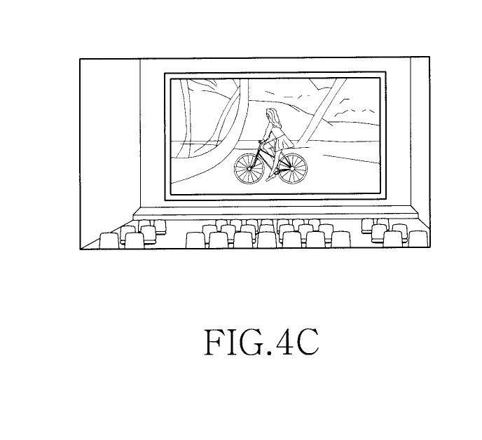

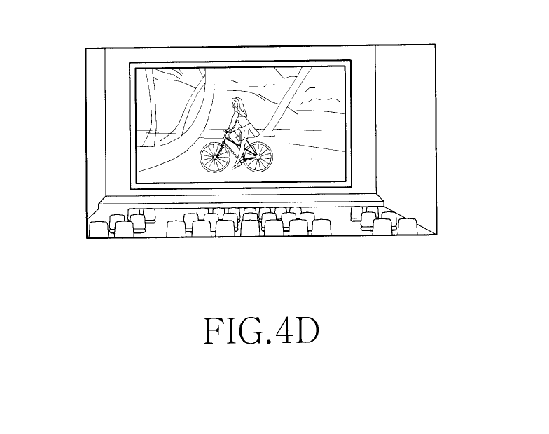

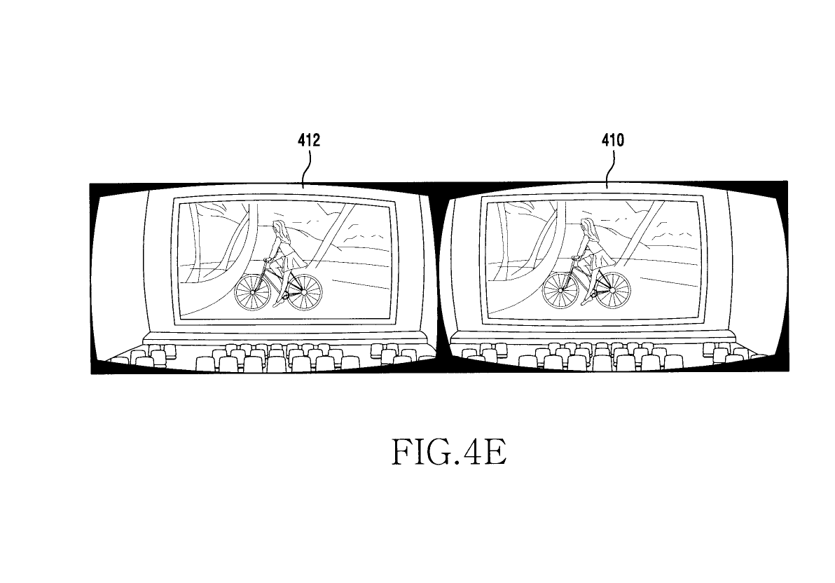

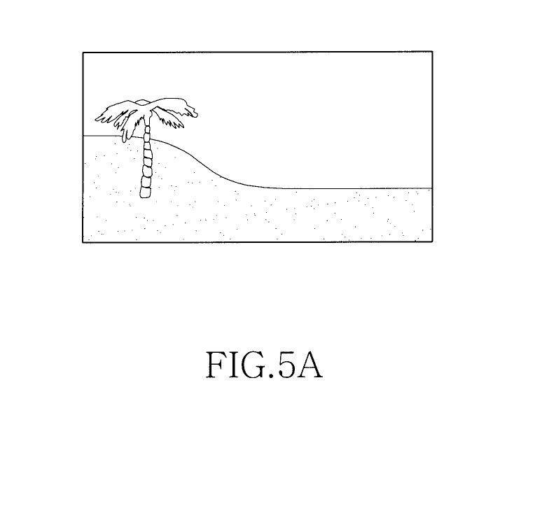

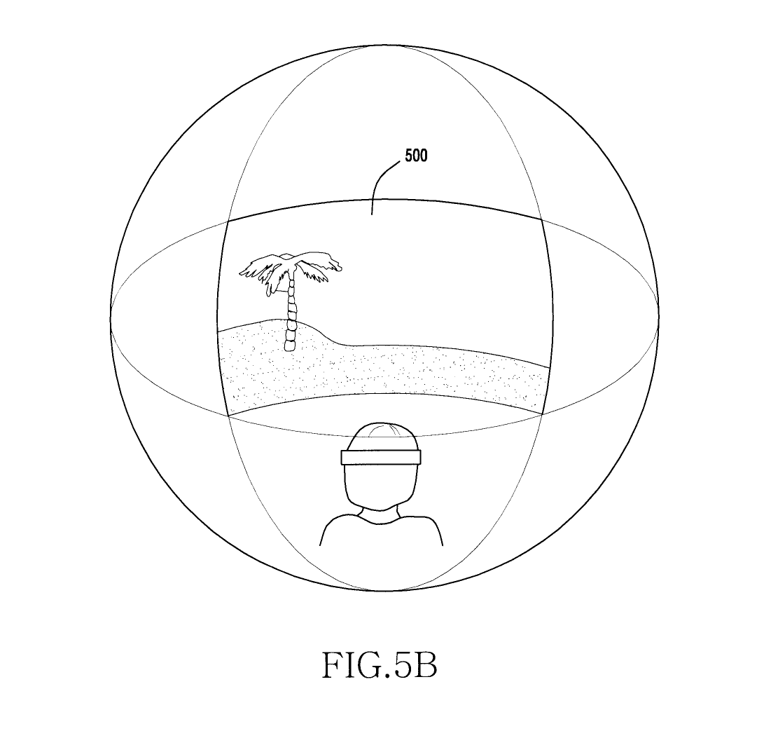

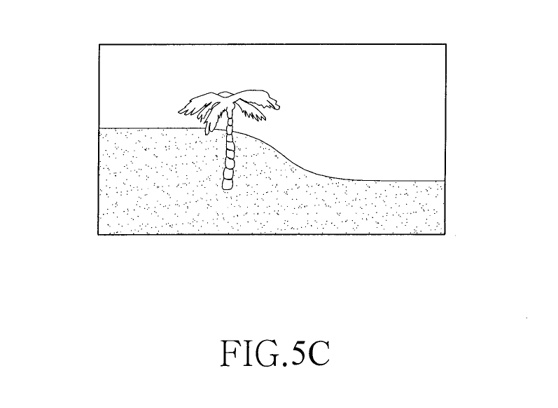

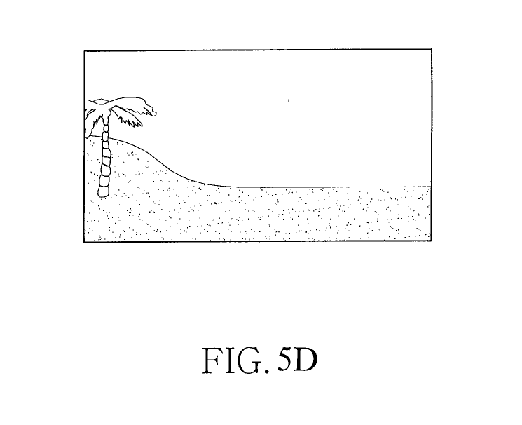

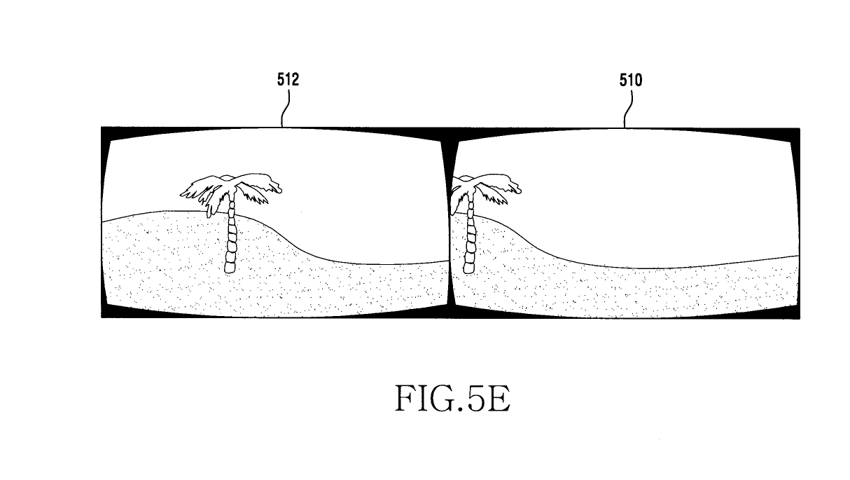

FIG. 3 is a block diagram of an example of a processor, according to aspects the present disclosure. Hereinafter, a virtual reality service may be described using screen configurations of FIGS. 4A to 4E and FIGS. 5A to 5E.

Referring to FIG. 3, the processor 220 may be used to implement a virtual reality processing module 300, a binocular separation module 310, a lens correction module 330, a buffer 340, and a capture control module 350. Each of the modules may be implemented by using hardware, software, or a combination of hardware and software.

The virtual reality processing module 300 may generate a virtual reality image mapped to a virtual reality environment by using an image to be displayed on the display 250. For example, when a virtual reality service for watching a movie in a theater is provided, the virtual reality processing module 300 may generate a virtual reality image (for example, two-dimensional virtual reality image) generated by mapping an original image of FIG. 4A to a screen area 400 for the virtual reality service for watching the movie in the theater as illustrated in FIG. 4B. For example, the virtual reality processing module 300 may map the original image of FIG. 4A to the screen area 400 as illustrated in FIG. 4B by controlling a resolution to make the original image fit the size of the screen area 400. For example, when a virtual reality service for virtual travel is provided, the virtual reality processing module 300 may generate a virtual reality image (for example, three-dimensional virtual reality image) by transforming an original image of FIG. 5A in accordance with the geometry of a virtual reality space (for example, a stereoscopic space) 500 for the virtual reality service for making the user feel as if the user is located in a particular area as illustrated in FIG. 5B. For example, the virtual reality processing module 300 may generate a virtual reality image by rendering the original image of FIG. 5A to correspond to a spherical, cubic, semi-spherical (sky dome), or cylindrical virtual reality space.

According to an embodiment, the binocular separation module 310 may generate a right eye image and a left eye image corresponding to the user's eyes by using the virtual reality image generated by the virtual reality processing module 300. For example, the binocular separation module 310 may generate a right eye image as illustrated in FIG. 4C and a left eye image as illustrated in FIG. 4D, in order to emulate binocular parallax, by using the generated virtual reality image as illustrated in FIG. 4B. For example, the binocular separation module 310 may generate a right eye image as illustrated in FIG. 5C and a left eye image as illustrated in FIG. 5D, in order to emulate a binocular parallax, by using the generated virtual reality image as illustrated in FIG. 5B.

According to an embodiment, the right eye image and the left eye image generated by binocular separation module 310 may be the same. For example, when the electronic device 200 displays a two-dimensional planar image, the binocular separation module 310 may generate the same right eye image and left eye image. When the electronic device 200 displays a three-dimensional image, the same left eye image and right eye image.

The lens correction module 330 may pre-distort the right eye image and the left eye image corresponding to distortion associated with the lenses of the optical unit 120. The lens correction module 330 may provide the pre-distorted images to the display 250 in order to compensate for any distortion that might be imparted on the images by the lenses. For example, the display 250 may display a pre-distorted right eye image 410 and left eye image 412 as illustrated in FIG. 4E. For example, the display 250 may display a pre-distorted right eye image 510 and left eye image 512 as illustrated in FIG. 5E.

The buffer 340 may temporarily store the images generated by the components of the processor 220 (for example, the virtual reality processing module 300, the binocular separation module 310, or the lens correction module 330). For example, the buffer 340 may store images generated by each component of the processor 220 in a plurality of logically or physically separated storage areas.

When the display 250 provides the virtual reality service through the stereo display, the capture control module 350 may capture the screen displayed on the display 250.

According to an embodiment, when an input for capturing the screen is detected while the virtual reality service is provided, the capture control module 350 may select, from one or more virtual reality images stored in the buffer 340, a virtual reality image corresponding to the screen displayed on the display 250 as a captured image.

According to an embodiment, when an input for capturing the screen is detected while the virtual reality service is provided, the capture control module 350 may select at least one of the right eye image and the left eye image, which are stored in the buffer 340 and correspond to the screen displayed on the display 250, as a captured image. For example, the capture control module 350 may randomly select one of the right eye image and the left eye image corresponding to the screen displayed on the display 250. For example, the capture control module 350 may select one of the right eye image and the left eye image corresponding to the screen displayed on the display 250 based on a preset selection parameter. For example, the capture control module 350 may select one of the right eye image and the left eye image corresponding to the screen displayed on the display 250 based on user focus configuration information of the display 250 determined through the focus adjustable module 116 of the HMD device 100.

According to an embodiment, when an input for capturing the screen is detected while the virtual reality service is provided, the capture control module 350 may estimate an intermediate viewpoint corresponding to the user's right eye and left eye. The capture control module 350 may generate an image corresponding to the intermediate viewpoint by using the virtual reality image corresponding to the screen displayed on the display 250, which is stored in the buffer 340. The capture control module 350 may determine the image corresponding to the intermediate viewpoint as the captured image.

According to an embodiment, when an input for capturing the screen is detected while the virtual reality service is provided, the capture control module 350 may combine the right eye image and the left eye image corresponding to the screen displayed on the display 250 and determine a depth value of an object included in the image. The capture control module 350 may generate a stereoscopic image in which each object is displayed according to the depth value. The capture control module 350 may determine the stereoscopic image as the captured image corresponding to the screen displayed on the display 250. For example, the capture control module 350 may configure a pixel difference between the position of the object in the right eye image and the position of the object in the left eye image as a depth value of the corresponding object.

According to an embodiment, when an input for capturing the screen is detected while the virtual reality service is provided, the capture control module 350 may generate image information in one or more directions (for example, six directions (up, down, left, right, front, and back) or all directions) based on a viewport. The capture control module 350 may generate the captured image corresponding to the screen displayed on the display 250 by using the image information in each direction. For example, the capture control module 350 may render the image corresponding to each direction and generate image information corresponding to each direction.

According to various embodiments of the present disclosure, the processor 220 may temporarily store the images generated by the components of the processor 220 (for example, the virtual reality processing module 300, the binocular separation module 310, or the lens correction module 330) by using the memory 230.

According to various embodiments of the present disclosure, an electronic device (for example, the electronic device 200 of FIG. 2) includes: a processor for generating a virtual reality image to be applied to a virtual reality environment, generating a right eye image and a left eye image based on the virtual reality image, and pre-distorting the right eye image and the left eye image based on lens distortion; and a display for displaying a stereo image by using the right eye image and left eye image pre-distorted by the processor, wherein the processor generates a captured image by using the virtual reality image corresponding to the stereo image displayed on the display in response to a capture input.

According to an embodiment of the present disclosure, the electronic device may further include a memory, wherein the processor may select, from one or more virtual reality images stored in the memory, the virtual reality image corresponding to the stereo image displayed on the display as the captured image.

According to an embodiment of the present disclosure, the processor may estimate an intermediate viewpoint between the user's eyes in response to the capture input, and generate a captured image corresponding to the intermediate viewpoint by using the virtual reality image corresponding to the stereo image displayed on the display.

According to an embodiment of the present disclosure, the processor may generate a two-dimensional virtual reality image by re-configuring an original image or at least one piece of data related to the original image in accordance with the virtual reality environment.

According to an embodiment of the present disclosure, the processor may generate a three-dimensional virtual reality image by rendering an original image or at least one piece of data related to the original image in accordance with the virtual reality space, and the virtual reality space may be formed in at least one shape of a sphere, a rectangle, a cylinder, and a semi-sphere.

According to an embodiment of the present disclosure, the processor may generate a right eye image and a left eye image corresponding to a user's binocular viewpoint based on the virtual reality image or generate a right eye image and a left eye image, which are equal to each other, based on the virtual reality image.

According to various embodiments of the present disclosure, an electronic device (for example, the electronic device 200 of FIG. 2) includes: a processor for generating a virtual reality image to be applied to a virtual reality environment, generating a right eye image and a left eye image based on the virtual reality image, and pre-distorting the right eye image and the left eye image based on lens distortion; and a display for displaying a stereo image by using the right eye image and left eye image pre-distorted by the processor, wherein the processor generates a captured image by using at least one of the right eye image and the left eye image corresponding to the stereo image displayed on the display in response to a capture input.

According to an embodiment of the present disclosure, the processor may select, from the right eye image and the left eye image, one image corresponding to the stereo image displayed on the display as the captured image in response to the capture input.

According to an embodiment of the present disclosure, the processor may select, from the right eye image and the left eye image, one image corresponding to the stereo image displayed on the display as the captured image based on an inter-pupil distance.

According to an embodiment of the present disclosure, the processor may generate the captured image by combining the right eye image and the left eye image corresponding to the stereo image displayed on the display in response to the capture input.

According to an embodiment of the present disclosure, the processor may generate a two-dimensional virtual reality image by re-configuring an original image or at least one piece of data related to the original image in accordance with the virtual reality environment.

According to an embodiment of the present disclosure, the processor may generate a three-dimensional virtual reality image by rendering an original image or at least one piece of data related to the original image in accordance with the virtual reality space, and the virtual reality space may be formed in at least one shape of a sphere, a rectangle, a cylinder, and a semi-sphere.

According to an embodiment of the present disclosure, the processor may generate a right eye image and a left eye image corresponding to a user's binocular viewpoint based on the virtual reality image or generate a right eye image and a left eye image, which are equal to each other, based on the virtual reality image.

According to various embodiments of the present disclosure, an electronic device (for example, the electronic device 200 of FIG. 2) includes: a display for displaying a stereo image in a viewport within a virtual reality space; and a processor for capturing information related to one or more images corresponding to one or more directions based on the viewport within the virtual reality space in response to a capture input.

According to an embodiment of the present disclosure, the processor may capture information related to a plurality of images corresponding to different directions based on the viewport within the virtual reality space in response to the capture input.

According to an embodiment of the present disclosure, the processor may generate spherical images corresponding to all directions based on the viewport within the virtual reality space in response to the capture input.

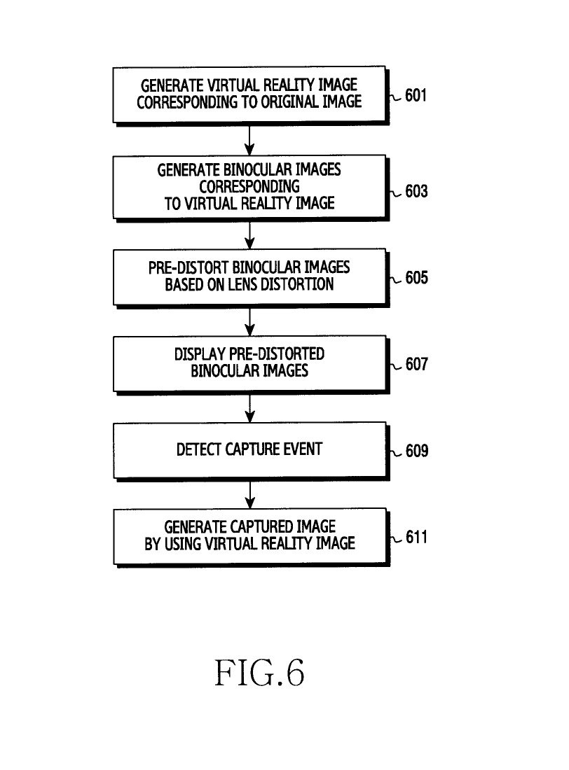

FIG. 6 is a flowchart of an example of a process in which the electronic device generates a captured image by using a virtual reality image, according to aspects of the present disclosure.

Referring to FIG. 6, in operation 601, the electronic device (for example, the electronic device 200 of FIG. 2) may generate a virtual reality image corresponding to an original image. For example, when a virtual reality service of watching a movie in a theater is provided, the electronic device may generate a virtual reality image by mapping the original image of FIG. 4A to the screen area 400 of the theater as illustrated in FIG. 4B. For example, when a virtual reality service of virtual travel is provided, the electronic device may generate a virtual reality image by mapping the original image of FIG. 5A to the virtual reality space 500 as illustrated in FIG. 5B.

In operation 603, the electronic device may generate binocular images by using the virtual reality image. For example, the electronic device may generate the right eye image as illustrated in FIG. 4C and the left eye image as illustrated in FIG. 4D by using the generated virtual reality image shown in FIG. 4B. For example, the electronic device may generate the right eye image as illustrated in FIG. 5C and the left eye image as illustrated in FIG. 5D, which can be used together to emulate a binocular parallax.

In operation 605, the electronic device may pre-distort the binocular images based on lens distortion in order to compensate for any distortion that might be introduced by the lenses of the HMD device 100.

In operation 607, the electronic device may display the pre-distorted binocular images on the display 250. For example, the electronic device may provide the virtual reality service by displaying the pre-distorted binocular images in different areas of the display 250 as illustrated in FIGS. 4E and 5E.

In operation 609, the electronic device may detect whether a capture event is generated. For example, the electronic device may identify whether an input for the capture event is detected through a control module, a sensor module, or an input/output interface of the HMD device 100.

In operation 611, when the electronic device detects the generation of the capture event, the electronic device may generate a captured image by using the virtual reality image corresponding to the screen displayed on the display 250. For example, the electronic device may select, from virtual reality images stored in the buffer 340, the virtual reality image corresponding to the screen displayed on the display 250 as the captured image.

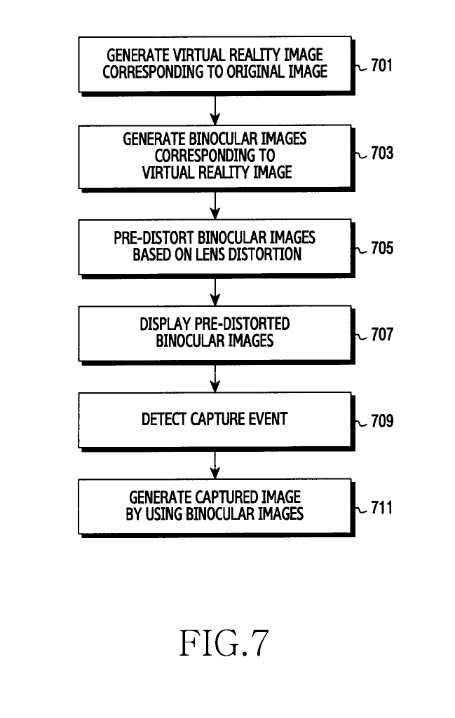

FIG. 7 is a flowchart of an example of a process in which the electronic device generates a captured image by using binocular images, according to aspects of the present disclosure.

Referring to FIG. 7, in operation 701, the electronic device (for example, the electronic device 200 of FIG. 2) may generate a virtual reality image corresponding to an original image.

In operation 703, the electronic device may generate binocular images by using the virtual reality image.

In operation 705, the electronic device may pre-distort the binocular images based on lens distortion in order to allow the user to recognize non-distorted images through the lenses of the optical unit 120 included in the HMD device 100.

In operation 707, the electronic device may display the pre-distorted binocular images on the display 250. For example, the electronic device may provide the virtual reality service by displaying the pre-distorted binocular images in different areas of the display 250.

In operation 709, the electronic device may detect whether a capture event is generated. For example, the electronic device may identify whether an input for the capture event is detected.

In operation 711, when the electronic device detects the generation of the capture event, the electronic device may generate a captured image by using binocular images corresponding to the screen displayed on the display 250.

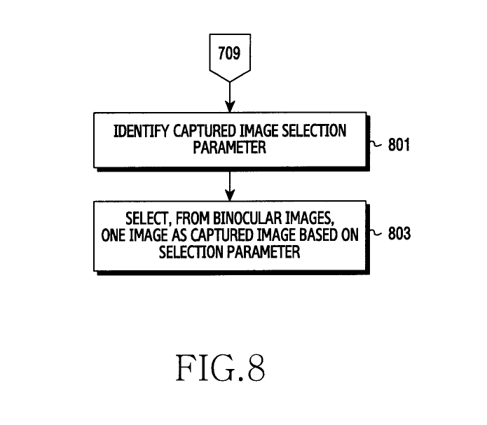

FIG. 8 is a flowchart of an example of a sub-process for generating a captured image by using binocular images, as discussed with respect to operation 711 of FIG. 7.

Referring to FIG. 8, when the electronic device detects the generation of the capture event in operation 709 of FIG. 7, the electronic device may identify a captured image selection parameter in operation 801. For example, the electronic device may identify the determined captured image selection parameter through a menu configuration mode. For example, the electronic device may determine the corresponding captured image selection parameter based on information on Inter-Pupil Distance (IPD) of the user. For example, the electronic device may estimate the IPD by using feedback information on the stereo display image displayed on the display 250.

In operation 803, the electronic device may select one of the right eye image and the left eye image as the captured image. The selection may be performed based on the image selection parameter.

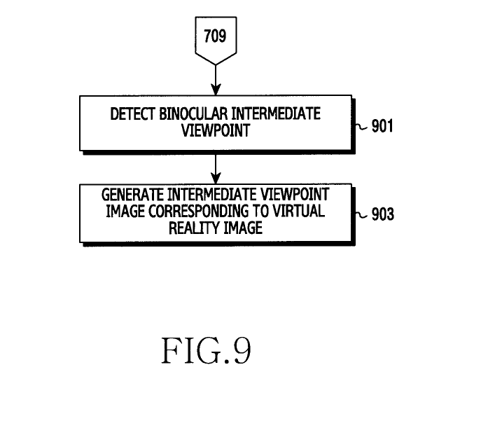

FIG. 9 is a flowchart of another example of a sub-process for generating a captured image by using binocular images, as discussed with respect to operation 711 of FIG. 7. The following description explains the operation for generating the captured image in operation 711 of FIG. 7.

Referring to FIG. 9, when the electronic device detects the generation of the capture event in operation 709 of FIG. 7, the electronic device may detect an intermediate viewpoint of both eyes in operation 901.

In operation 903, the electronic device may generate an image corresponding to an intermediate viewpoint by using the virtual reality image corresponding to the screen displayed on the display 250. The electronic device may then use the image corresponding to the intermediate viewpoint as the captured image.

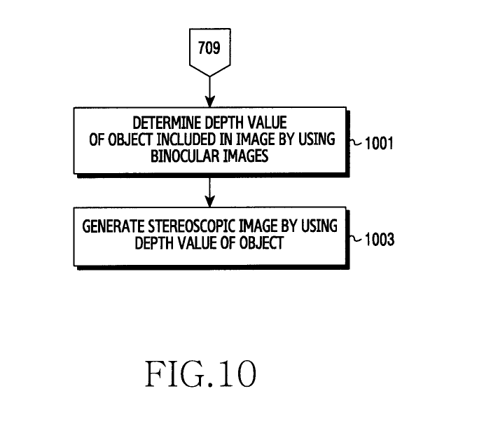

FIG. 10 is a flowchart of yet another example of a sub-process for generating a captured image by using binocular images, as discussed with respect to operation 711 of FIG. 7.

Referring to FIG. 10, when the electronic device detects the generation of the capture event in operation 709 of FIG. 7, the electronic device may determine a depth values associated with an object depicted in the binocular images corresponding to the screen displayed on the display 250 in operation 1001. For example, the electronic device may use a pixel difference between the position of the object in the right eye image and the position of the object in the left eye image as the depth value of the corresponding object.

In operation 1003, the electronic device may generate a stereoscopic image in which each object is displayed according to the depth value of the object. The electronic device may use the stereoscopic image as the captured image.

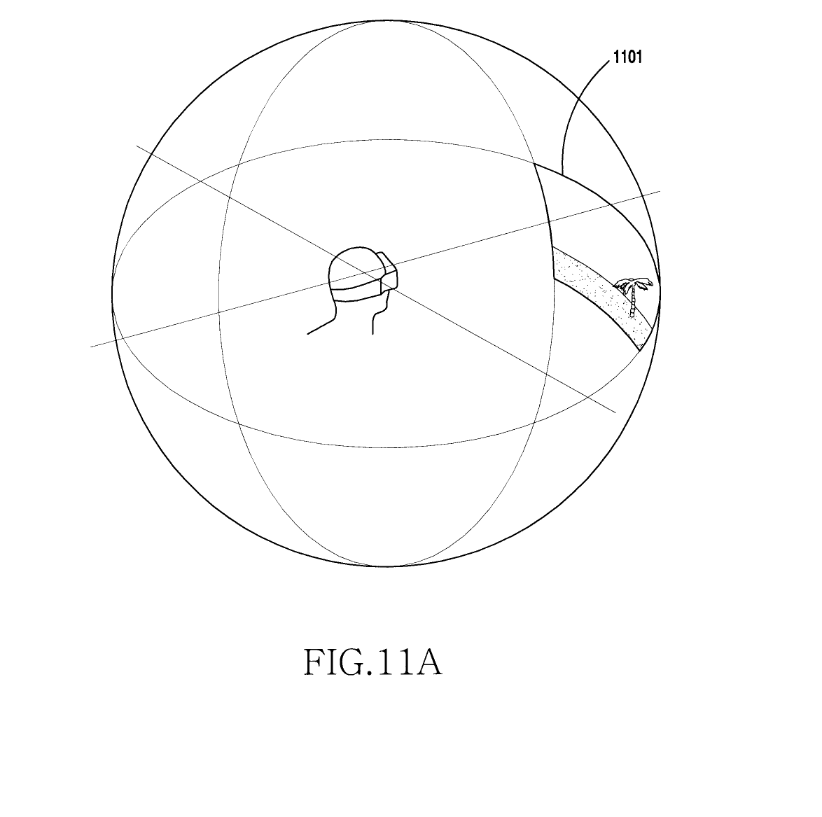

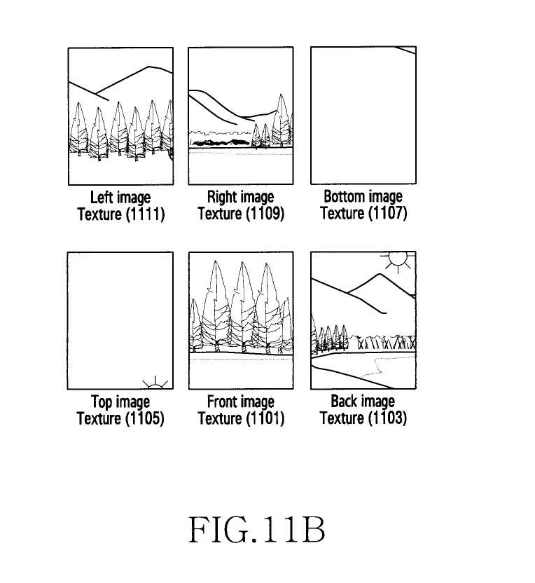

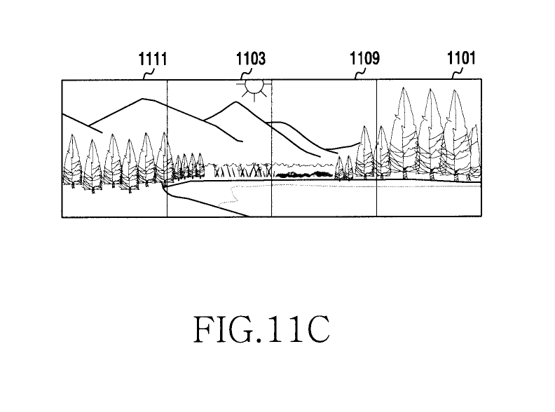

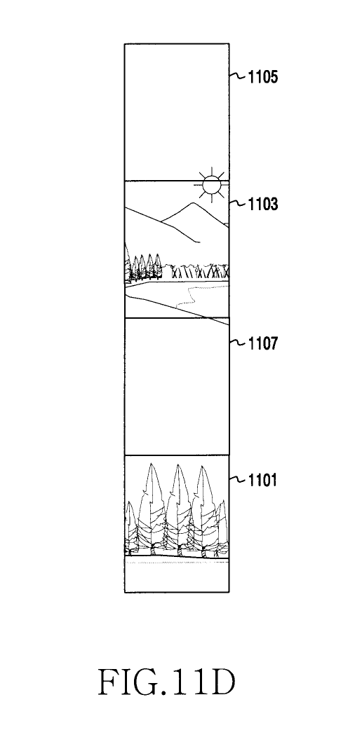

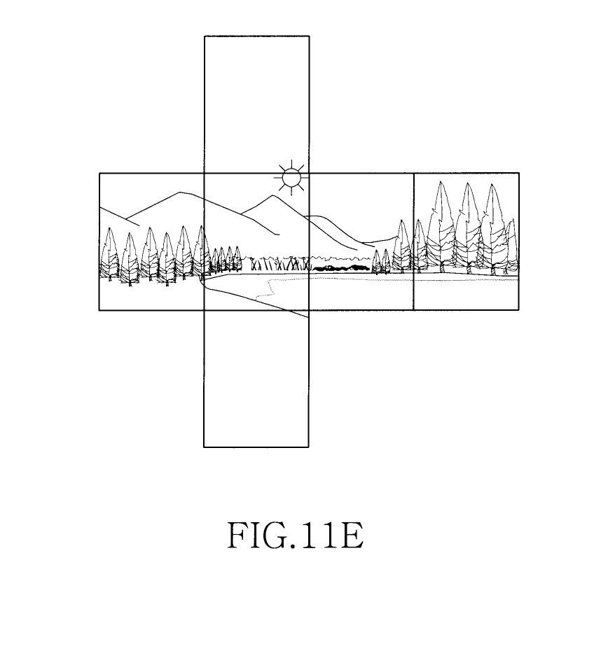

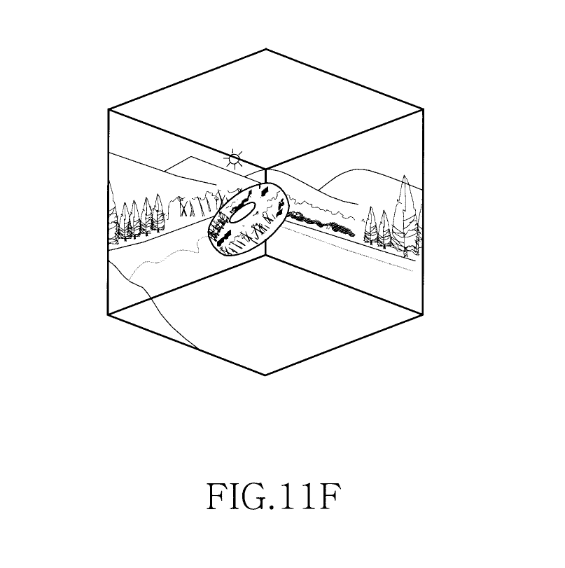

FIGS. 11A to 11F illustrate screen configurations for capturing information in the virtual reality environment according to an embodiment of the present disclosure.

Referring to FIG. 11A, when a virtual reality service is provided, the electronic device (for example, the electronic device 200 of FIG. 2) may display an image in a viewport 1101 of the virtual reality space. The electronic device may track a motion of the user's head and change the image (for example, image corresponding to a changed viewport) displayed on the display according to the direction of the motion.

According to an embodiment, when an input for capturing the screen is detected while the virtual reality service is provided, the electronic device may generate image information in directions of six sides (for example, a front image 1101, a back image 1103, a top image 1105, a bottom image 1107, a right eye image 1109, and a left eye image 1111) based on the viewport 1101 as illustrated in FIG. 11B. For example, the electronic device may store mapping information on images to be displayed in areas (for example, coordinates) except for the viewport in the virtual reality space. When the input for capturing the screen is detected, the electronic device may generate an image buffer for generating image information in each direction. The electronic device may project the image mapped to each direction onto the corresponding each of image buffer. The electronic device may render image information corresponding to each direction using the projected image. The electronic device may store the rendered image information in the memory 230.

When image information in directions of six sides is generated as illustrated in FIG. 11B, the electronic device (for example, the electronic device generating the captured image or the electronic device receiving the captured image) may display the captured image by using the image information in the directions of the six sides. In this case, the electronic device may change and display the captured image according to a display type.

According to an embodiment, when the electronic device two-dimensionally reproduces the captured images, the electronic device may display the captured images in an order of the left eye image information 1111, the back image information 1103, the right eye image information 1109, and the front image information 1101 sequentially in a horizontal direction as illustrated in FIG. 11C. The electronic device may display at least some of the captured images on the display 250 and change the captured images displayed on the display 250 based on input information detected through the input/output interface 240.

According to an embodiment, when the electronic device two-dimensionally reproduces the captured images, the electronic device may display the captured images in an order of the top image information 1105, the back image information 1103, the bottom image information 1107, and the front image information 1101 sequentially in a vertical direction as illustrated in FIG. 11D. The electronic device may display at least some of the captured images on the display 250 and change the captured images displayed on the display 250 based on input information detected through the input/output interface 240.

According to an embodiment, when the electronic device two-dimensionally reproduces the captured images, the electronic device may display the captured images in an order of the image information in directions of six sides 1101, 1103, 1105, 1107, 1109, and 1111 sequentially in a horizontal direction or vertical direction as illustrated in FIG. 11E. The electronic device may display at least some of the captured images on the display 250 and change the captured images displayed on the display 250 based on input information detected through the input/output interface 240.

According to an embodiment, when the electronic device three-dimensionally reproduces the captured images, the electronic device may render a virtual space (for example, a cubic virtual space) by using the image information in directions of six sides 1101, 1103, 1105, 1107, 1109, and 1111 and display the captured images as illustrated in FIG. 11F.

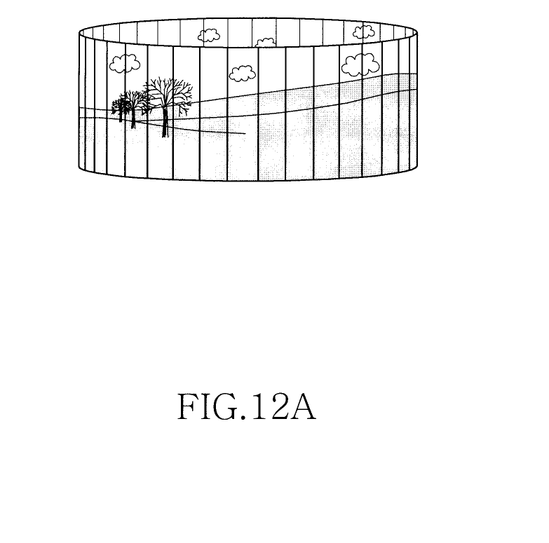

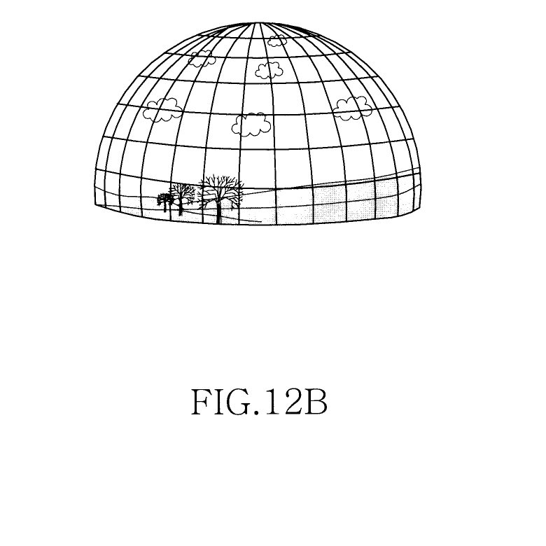

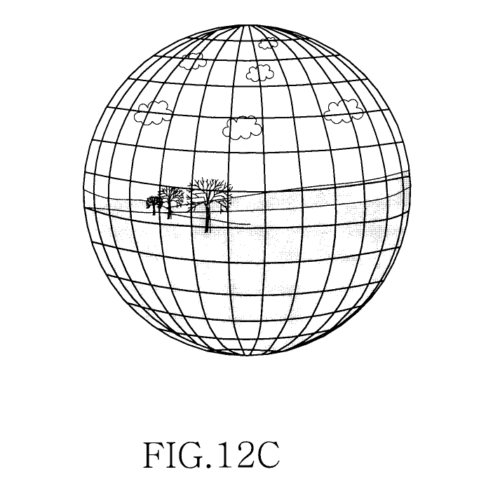

FIGS. 12A to 12C illustrate screen configurations for capturing information in the virtual reality environment according to an embodiment of the present disclosure.

According to an embodiment, when an input for capturing the screen is detected while the virtual reality service is provided, the electronic device may generate image information in one or more horizontal directions based on a viewport in order to generate a cylindrical captured image as illustrated in FIG. 12A. For example, the electronic device may generate an image buffer for generating image information in a horizontal direction based on a view port in response to the input for capturing the screen. The electronic device may project the image mapped to each direction onto the corresponding each of image buffer. The electronic device may render image information corresponding to each direction using the projected image. The electronic device may store the rendered image information in the memory 230.

According to an embodiment, when an input for capturing the screen is detected while the virtual reality service is provided, the electronic device may generate image information in one or more directions semi-spherically based on a viewport in order to generate a semi-spherical (for example, sky dome) captured image as illustrated in FIG. 12B.

According to an embodiment, when an input for capturing the screen is detected while the virtual reality service is provided, the electronic device may generate image information in one or more directions omni-directionally based on a viewport in order to generate a spherical captured image as illustrated in FIG. 12C.

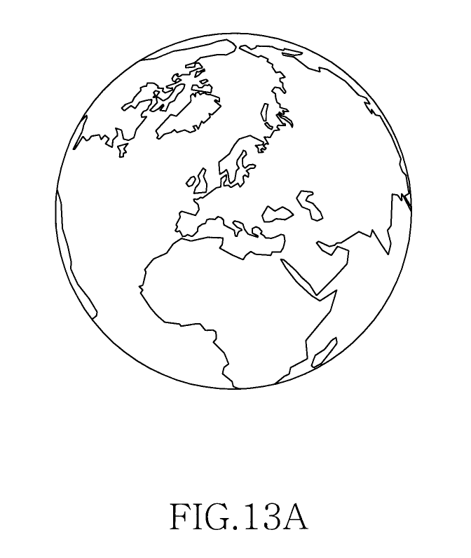

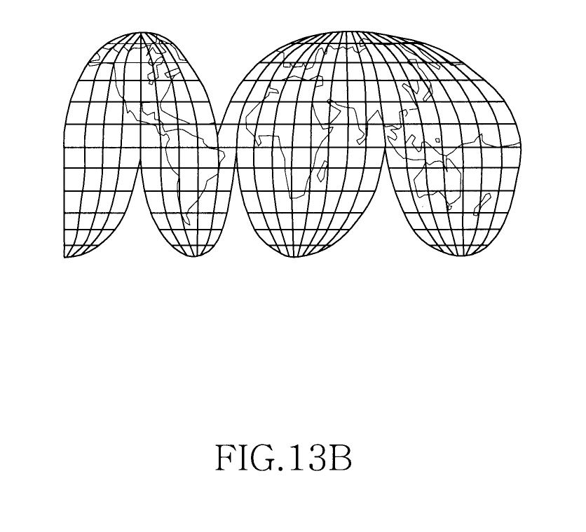

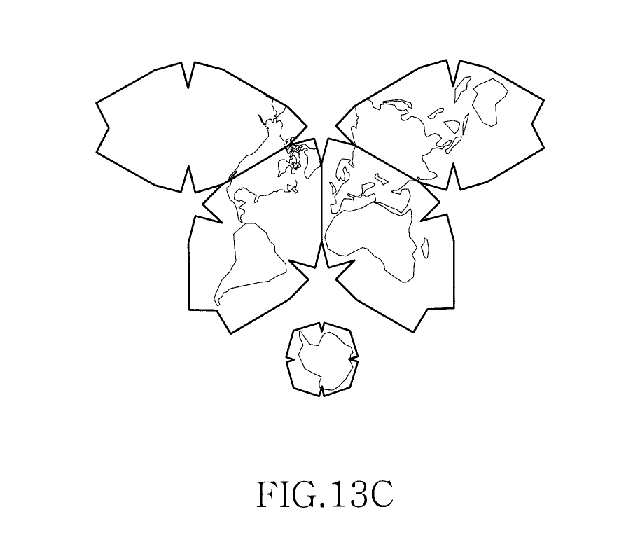

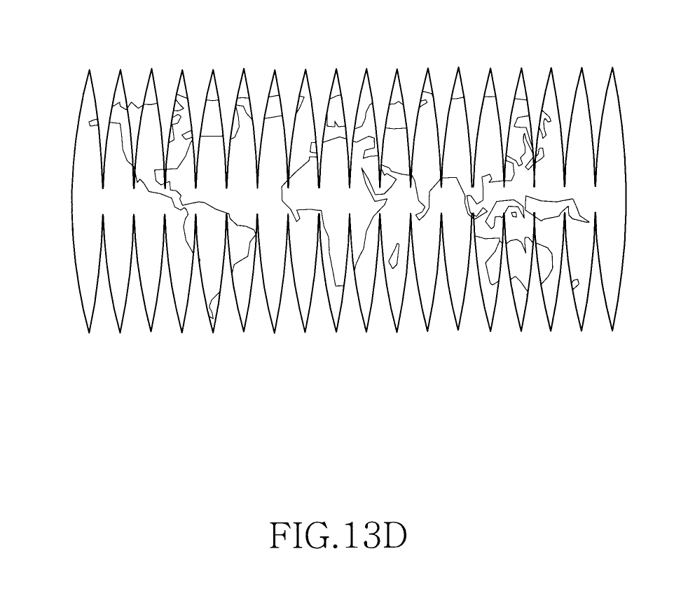

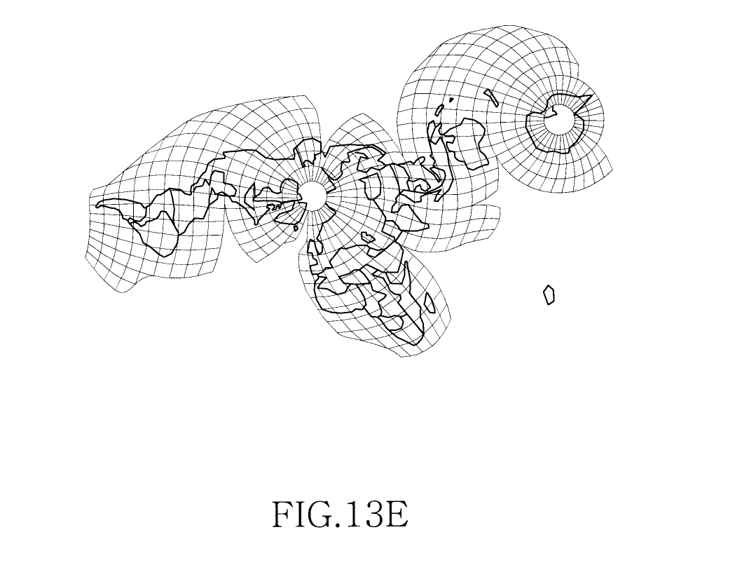

FIGS. 13A to 13E illustrate image formats for sharing the captured image according to an embodiment of the present disclosure.

According to an embodiment, the electronic device may display a stereoscopic (for example, spherical) captured image (for example, a captured image for the virtual reality service using a map) as illustrated in FIG. 13A or transmit the captured stereoscopic image to a counterpart device (for example, another electronic device or a server).

According to an embodiment, the electronic device may convert the captured stereoscopic image into a two-dimensional planar image as illustrated in FIG. 13B and display the two-dimensional planar image on the display 250 or transmit the two-dimensional planar image to a counterpart device.

According to an embodiment, the electronic device may convert the captured stereoscopic image into a two-dimensional planar image based on a viewport of the user (for example, due north) as illustrated in FIG. 13C and display the two-dimensional planar image on the display 250 or transmit the two-dimensional planar image to a counterpart device.

According to an embodiment, the electronic device may convert each piece of information including the captured stereoscopic image into a two-dimensional planar image as illustrated in FIG. 13D and display the two-dimensional planar image on the display 250 or transmit the two-dimensional planar image to a counterpart device.

According to an embodiment, the electronic device may convert the captured stereoscopic image into a two-dimensional planar image as illustrated in FIG. 13E and display the two-dimensional planar image on the display 250 or transmit the two-dimensional planar image to a counterpart device.

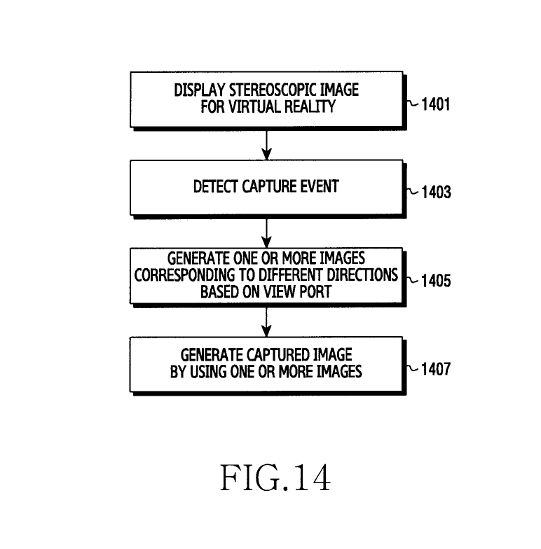

FIG. 14 is a flowchart of an example of a process, according to aspects of the disclosure.

Referring to FIG. 14, in operation 1401, the electronic device (for example, the electronic device 200 of FIG. 2) may display a stereoscopic image for a virtual reality. For example, when a virtual reality service is provided, the electronic device may display the image of the viewport 1101 in the virtual reality space as illustrated in FIG. 11A.

In operation 1403, the electronic device may detect whether a capture event is generated. For example, the electronic device may identify whether an input for the capture event is detected.

In operation 1405, when the electronic device detects the generation of the capture event, the electronic device may generate one or more pieces of image information corresponding to one or more directions. For example, the electronic device may generate an image buffer for generating image information in reference directions (for example, the front image 1101, the back image 1103, the top image 1105, the bottom image 1107, the right eye image 1109, and the right eye image 1111), project the image mapped to each direction onto the corresponding image buffer to render image information corresponding to each direction, and store the image information in the memory 230. For example, the electronic device may store the image information after adding corresponding direction information to the image information. For example, the electronic device may generate image information corresponding to each reference direction by using the image capture type as illustrated in FIG. 6 or 7.

In operation 1407, the electronic device may generate a captured image by using the image information corresponding to each direction. For example, the electronic device may generate a captured image corresponding to a display type of the captured image by using the image information corresponding to each direction.

According to an embodiment, the electronic device may transmit the captured image in the form of image information in each direction to a server or an external electronic device.

According to an embodiment, the electronic device may generate a two-dimensional image by using the image information in each direction and transmit the two-dimensional image to a server or an external electronic device.

According to an embodiment, the electronic device may generate a three-dimensional captured image (for example, spherical image) by using the image information in each direction and transmit the three-dimensional image to a server or an external electronic device.

According to an embodiment, the electronic device may generate a two or three-dimensional captured image according to a display type (for example, two dimension or three-dimension) of an external electronic device to which the captured image will be transmitted, and transmit the generated two or three-dimensional captured image to the external electronic device.

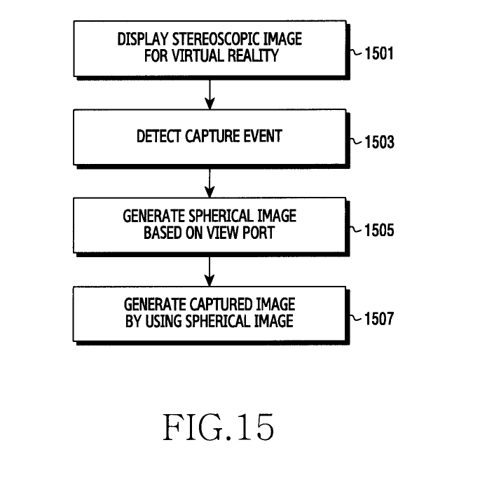

FIG. 15 is a flowchart of an example of a process, according to aspects of the disclosure. In operation 1501, the electronic device (for example, the electronic device 200 of FIG. 2) may display a stereoscopic image. For example, when a virtual reality service is provided, the electronic device may display the image of the viewport 1101 in the virtual reality space as illustrated in FIG. 11A.

In operation 1503, the electronic device may detect whether a capture event is generated. For example, the electronic device may identify whether an input for the capture event is detected.

In operation 1505, when the electronic device detects the generation of the capture event, the electronic device may generate spherical image information based on the viewport. For example, the electronic device may generate a virtual spherical image buffer (for example, 360-degree image buffer) and project the virtual space on the virtual spherical image buffer to render spherical image information.

According to an embodiment, the electronic device may transmit the spherical image information to a server or an external electronic device.

According to an embodiment, the electronic device may convert the spherical image information into a two-dimensional captured image and transmit the two-dimensional captured image to a server or an external electronic device.

According to an embodiment, the electronic device may generate a two or three-dimensional captured image according to a display type (for example, two dimension or three dimension) of an external electronic device to which the captured image will be transmitted, and transmit the generated two or three-dimensional captured image to the external electronic device.

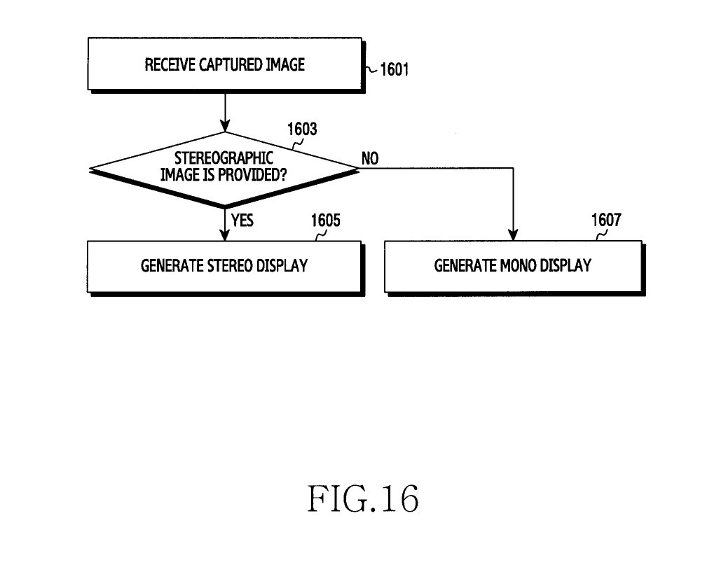

FIG. 16 is a flowchart of an example of a process, according to aspects of the disclosure.

Referring to FIG. 16, in operation 1601, the electronic device (for example, the electronic device 200 of FIG. 2) may receive a captured image. For example, the electronic device may receive the captured image from a particular service server (for example, a social network server or a messenger server). For example, the electronic device may receive the captured image from an external electronic device.

In operation 1603, the electronic device may identify whether a stereographic image can be provided. For example, in a case of FIG. 1B, it may be identified whether the electronic device 132 is mounted on the HMD device 100.

When the electronic device can provide the stereographic image, the electronic device may generate a stereo display by using the captured image in operation 1605. For example, the electronic device may generate a virtual reality image by using the captured image, generate binocular images by using the virtual reality image, and display the stereoscopic image for the virtual reality on the display 250. For example, the electronic device may display the stereoscopic image for the virtual reality on the display 250 by using stereoscopic image information included in the captured image.

When the electronic device cannot provide the stereographic image, the electronic device may generate a mono display by using the captured image in operation 1607. For example, when the virtual reality service for the mono display is provided, the electronic device may generate a rendered spherical image corresponding to the captured image and provide the virtual reality service in a mono environment.

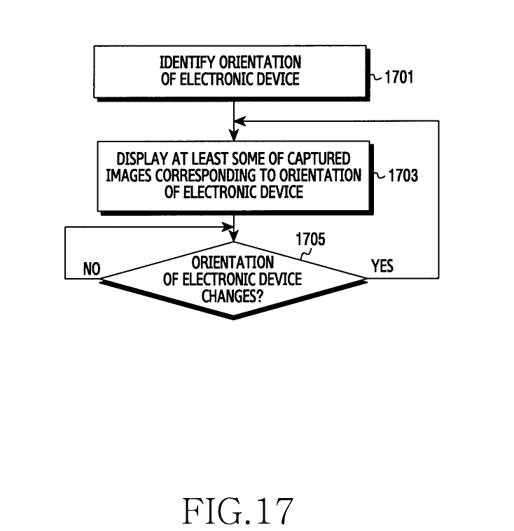

FIG. 17 is a flowchart of an example of a process, according to aspects of the disclosure.

Referring to FIG. 17, in operation 1701, the electronic device (for example, the electronic device 200 of FIG. 2) may identify an orientation of the electronic device. For example, the electronic device may configure an opposite orientation of the display 250 as the orientation of the electronic device.

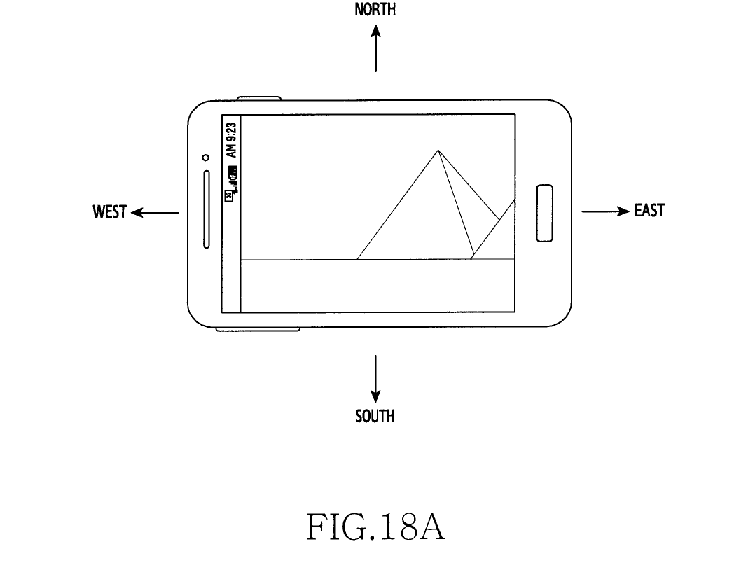

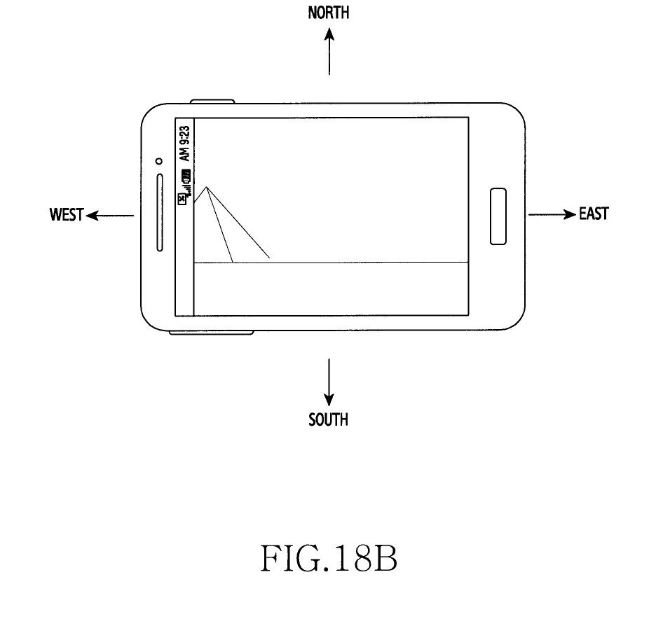

In operation 1703, the electronic device may display at least some of the captured images corresponding to the orientation (for example, direction) of the electronic device on the display 250. For example, when the orientation of the electronic device corresponds to the due north direction (N), the electronic device may extract at least some images corresponding to the due north direction from metadata of the captured image and display the extracted images on the display 250 as illustrated in FIG. 18A.

In operation 1705, the electronic device may identify whether the orientation of the electronic device changes.

When the orientation of the electronic device does not change in operation 1705, the electronic device may identify again whether the orientation of the electronic device changes.

When the orientation of the electronic device changes in operation 1703, the electronic device may change at least some of the captured images displayed on the display 250 in accordance with the change in the orientation of the electronic device. For example, the electronic device may change at least some of the captured images displayed on the display 250 in accordance with the change (movement to the east) in the orientation of the electronic device as illustrated in FIG. 18B.

According to an embodiment, when at least some of the captured images are displayed on the display 250 of the electronic device, the electronic device may change captured image areas displayed on the display 250 in accordance with input information detected through the input/output interface 240.

According to various embodiments of the present disclosure, a method of operating an electronic device may include: generating a virtual reality image to be applied to a virtual reality environment; generating a right eye image and a left eye image based on the virtual reality image; pre-distorting the right eye image and the left eye image based on lens distortion; displaying a stereo image by using the right eye image and left eye image pre-distorted by the processor; and generating a captured image by using the virtual reality image corresponding to the stereo image displayed on the display in response to a capture input.

According to an embodiment of the present disclosure, the generating of the virtual reality image may include generating a two-dimensional virtual reality image by re-configuring an original image or at least one piece of data related to the original image in accordance with the virtual reality environment.

According to an embodiment of the present disclosure, the generating of the virtual reality image may include generating a three-dimensional virtual reality image by rendering an original image or at least one piece of data related to the original image in accordance with the virtual reality space, and the virtual reality space is formed in at least one shape of a sphere, a rectangle, a cylinder, and a semi-sphere.

According to an embodiment of the present disclosure, the generating of the captured image may include selecting, from one or more virtual reality images stored in a memory of the electronic device, the virtual reality image corresponding to the stereo image displayed on the display as the captured image.

According to an embodiment of the present disclosure, the generating of the captured image may include: estimating an intermediate viewpoint between the user's eyes in response to the capture input; and generating a captured image corresponding to the intermediate viewpoint by using the virtual reality image corresponding to the stereo image displayed on the display.

According to an embodiment of the present disclosure, the generating of the right eye image and the left eye image may include generating the right eye image and the left eye image corresponding to a user's binocular viewpoint based on the virtual reality image.

According to an embodiment of the present disclosure, the generating of the right eye image and the left eye image may include generating the right eye image and the left eye image, which are equal to each other, based on the virtual reality image.

According to various embodiments of the present disclosure, a method of operating an electronic device may include: generating a virtual reality image to be applied to a virtual reality environment; generating a right eye image and a left eye image based on the virtual reality image; pre-distorting the right eye image and the left eye image based on lens distortion; displaying a stereo image by using the right eye image and left eye image pre-distorted by the processor; and generating a captured image by using at least one of the right eye image and the left eye image corresponding to the stereo image displayed on the display in response to a capture input.

According to an embodiment of the present disclosure, the generating of the virtual reality image may include generating a two-dimensional virtual reality image by re-configuring an original image or at least one piece of data related to the original image in accordance with the virtual reality environment.

According to an embodiment of the present disclosure, the generating of the virtual reality image may include generating a three-dimensional virtual reality image by rendering an original image or at least one piece of data related to the original image in accordance with the virtual reality space, and the virtual reality space is formed in at least one shape of a sphere, a rectangle, a cylinder, and a semi-sphere.

According to an embodiment of the present disclosure, the generating of the captured image may include selecting, from the right eye image and the left eye image, one image corresponding to the stereo image displayed on the display as the captured image in response to the capture input.

According to an embodiment of the present disclosure, the generating of the captured image may include selecting, from the right eye image and the left eye image, one image corresponding to the stereo image displayed on the display as the captured image based on an inter-pupil distance.

According to an embodiment of the present disclosure, the generating of the captured image may include generating the captured image by combining the right eye image and the left eye image corresponding to the stereo image displayed on the display in response to the capture input.

According to an embodiment of the present disclosure, the generating of the right eye image and the left eye image may include generating the right eye image and the left eye image corresponding to a user's binocular viewpoint based on the virtual reality image.

According to an embodiment of the present disclosure, the generating of the right eye image and the left eye image may include generating the right eye image and the left eye image, which are equal to each other, based on the virtual reality image.

According to various embodiments of the present disclosure, a method of operating an electronic device includes: displaying a stereo image in a viewport within a virtual reality space; and capturing information related to one or more images corresponding to one or more directions based on the viewport within the virtual reality space in response to a capture input.

According to an embodiment of the present disclosure, the capturing of the image information may include capturing information related to a plurality of images corresponding to different directions based on the viewport within the virtual reality space in response to the capture input.

According to an embodiment of the present disclosure, the capturing of the image information may include generating spherical images corresponding to all directions based on the viewport within the virtual reality space in response to the capture input.

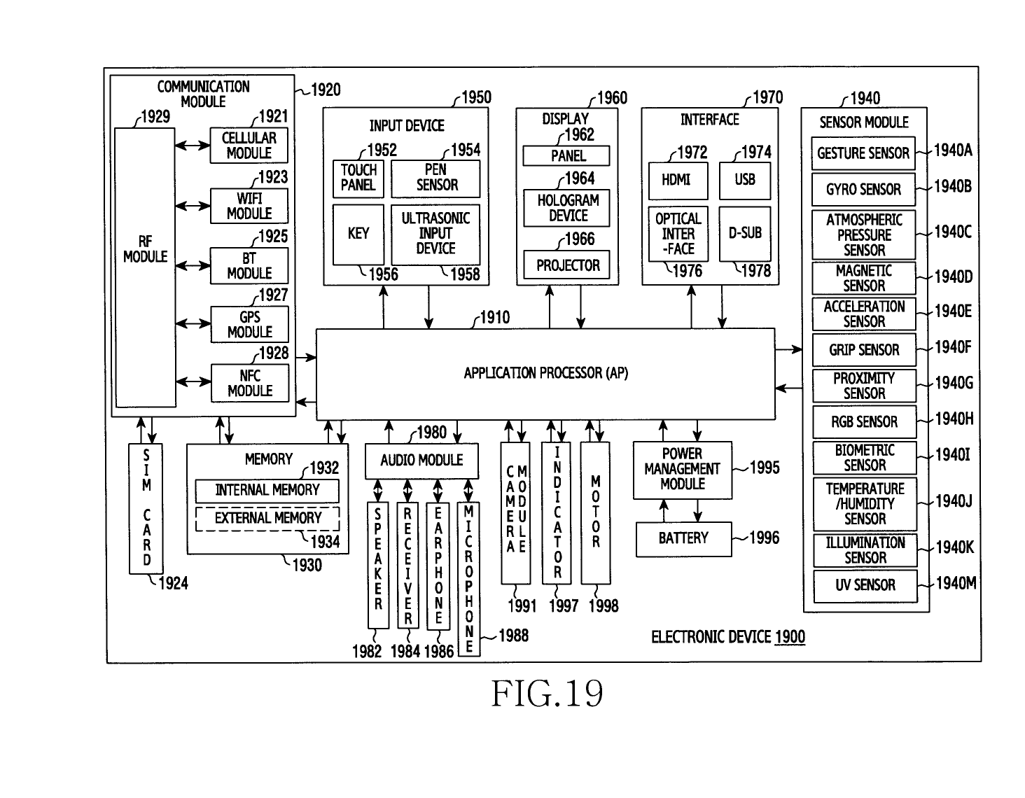

FIG. 19 is a block diagram of an electronic device according to an embodiment of the present disclosure. In the following description, an electronic device 1900 may constitute, for example, all or some of the electronic device 200 illustrated in FIG. 2.

Referring to FIG. 19, the electronic device 1900 may include at least one Application Processor (AP) 1910, a communication module 1920, a Subscriber Identification Module (SIM) card 1924, a memory 1930, a sensor module 1940, an input device 1950, a display 1960, an interface 1970, an audio module 1980, a camera module 1991, a power management module 1995, a battery 1996, an indicator 1997, and a motor 1998.

The AP 1910 may drive an operation system or an application program so as to control a plurality of hardware or software components connected to the AP 1910, and may execute data processing and operation associated with various data including multimedia data. The AP 1910 may be implemented by, for example, a System on Chip (SoC). According to an embodiment, the AP 1910 may further include a graphic processing unit (GPU) (not illustrated). According to an embodiment, an internal operation of the processor 220 illustrated in FIG. 3 may be performed simultaneously or sequentially by at least one of the AP 1910 or the GPU.

The communication module 1920 may transmit/receive data in communication between other electronic devices connected to the electronic device 1900 through a network. According to an embodiment of the present disclosure the communication module 1920 may include a cellular module 1921, a WiFi module 1923, a BlueTooth (BT) module 1925, a Global Positioning System (GPS) module 1927, a Near Field Communication (NFC) module 1928, and a Radio Frequency (RF) module 1929.

The cellular module 1921 may provide a voice call, a video call, a short message service (SMS), or an Internet service through a communications network (for example, LTE, LTE-A, CDMA, WCDMA, UMTS, WiBro, or GSM). Further, the cellular module 1921 may distinguish between and authenticate electronic devices in a communications network using, for example, a subscriber identification module (for example, the SIM card 1924). According to an embodiment, the cellular module 1921 may perform at least some of the functions that the AP 1910 may provide. For example, the cellular module 1921 may perform at least some of the multimedia control functions.

According to an embodiment, the cellular module 1921 may include a communication processor (CP). Further, the cellular module 1921 may be implemented by, for example, a SoC. Although the components such as the cellular module 1921 (for example, the communication processor), the memory 1930, or the power management module 1995 are illustrated as components separated from the AP 1910, the AP 1910 may include at least some of the above-described components (for example, the cellular module 1921) according to an embodiment.

According to an embodiment, the AP 1910 or the cellular module 1921 (for example, the communication processor) may load a command or data received from at least one of a non-volatile memory and other components connected thereto to a volatile memory and process the loaded command or data. Further, the AP 1910 or the cellular module 1921 may store data received from or generated by at least one of other components in a non-volatile memory.

For example, each of the Wi-Fi module 1923, the BT module 1925, the GPS module 1927, and the NFC module 1928 may include a processor for processing data transmitted/received through the corresponding module. Although each of the cellular module 1921, the WiFi module 1923, the BT module 1925, the GPS module 1927, and the NFC module 1928 is shown as a separate block in FIG. 19, at least some (for example, two or more) of the cellular module 1921, the WiFi module 1923, the BT module 1925, the GPS module 1927, and the NFC module 1928 may be included in one integrated chip (IC) or IC package according to an embodiment. For example, at least some (for example, the communication processor corresponding to the cellular module 1921 and the Wi-Fi processor corresponding to the Wi-Fi module 1923) of processors corresponding to the cellular module 1921, the Wi-Fi module 1923, the BT module 1925, the GPS module 1927, and the NFC module 1928 may be implemented as one SoC.

The RF module 1929 may transmit and receive data, for example, RF signals. The RF module 1929 may include, for example, a transceiver, a Power Amp Module (PAM), a frequency filter, a Low Noise Amplifier (LNA), or the like, although not illustrated. Further, the RF module 1929 may further include a component for transmitting and receiving an electromagnetic wave in the free airspace in wireless communication through, for example, a conductor or a conductive wire. Although the cellular module 1921, the Wi-Fi module 1923, the BT module 1925, the GPS module 1927, and the NFC module 1928 are illustrated to share one RF module 1929 in FIG. 19, at least one of the cellular module 1921, the Wi-Fi module 1923 the BT module 1925 the GPS module 1927 and the NFC module 1928 may transmit/receive the RF signal through a separate RF module according to an embodiment of the present disclosure.

According to an embodiment, the RF module 1929 may include at least one of a main antenna and a sub antenna, which is functionally connected to the electronic device 1900. The communication module 1920 may support a Multiple Input Multiple Output (MIMO) service such as diversity by using the main antenna and the sub antenna.

The SIM card 1924 may be a card including a subscriber identification module and may be inserted into a slot formed in a predetermined position of the electronic device. The SIM card 1924 may include unique identification information (e.g. an integrated circuit card identifier (ICCID)) or unique subscriber information (e.g., an international mobile subscriber identity (IMSI)).

The memory 1930 may include an internal memory 1932 or an external memory 1934. The internal memory 1932 may include at least one of a volatile memory (for example, a Dynamic Random Access Memory (DRAM), a Static RAM (SRAM), a Synchronous Dynamic RAM (SDRAM), and the like) and a non-volatile memory (for example, a One Time Programmable Read Only Memory (OTPROM), a Programmable ROM (PROM), an Erasable and Programmable ROM (EPROM), an Electrically Erasable and Programmable ROM (EEPROM), a mask ROM, a flash ROM, a NAND flash memory, a NOR flash memory, and the like).

According to an embodiment, the internal memory 1932 may be a Solid State Drive (SSD). The external memory 1934 may further include a flash drive, for example, a compact flash (CF), a secure digital (SD), a micro secure digital (Micro-SD), a mini secure digital (Mini-SD), an extreme digital (xD), a Memory Stick, or the like. The external memory 1934 may be functionally connected to the electronic device 1900 through various interfaces. According to an embodiment, the electronic device 1900 may further include a storage device (or storage medium) such as a hard disc drive.

The sensor module 1940 may measure a physical quantity or sense an operational state of the electronic device 1900 and may convert the measured or sensed information to an electric signal. The sensor module 1940 may include at least one of, for example, a gesture sensor 1940A, a gyro sensor 1940B, an atmospheric pressure sensor 1940C, a magnetic sensor 1940D, an acceleration sensor 1940E, a grip sensor 1940F, a proximity sensor 1940G, a color sensor 1940H (for example, a Red/Green/Blue (RGB) sensor), a biometric sensor 1940I, a temperature/humidity sensor 1940J, an illumination sensor 1940K, and an Ultra Violet (UV) sensor 1940M. Additionally or alternatively, the sensor module 1940 may, for example, include an E-nose sensor (not shown), an electromyography (EMG) sensor (not shown), an electroencephalogram (EEG) sensor (not shown), an electrocardiogram (ECG) sensor (not shown), an Infrared (IR) sensor (not shown), an iris sensor (not shown), a fingerprint sensor (not shown), and the like. The sensor module 1940 may further include a control circuit for controlling one or more sensors included therein.

The input device 1950 may include a touch panel 1952, a (digital) pen sensor 1954, a key 1956, or an ultrasonic input device 1958. The touch panel 1952 may recognize a touch input in at least one of, for example, a capacitive type, a resistive type, an infrared type, and an acoustic wave type. Further, the touch panel 1952 may further include a control circuit. In the case of the capacitive type, physical contact or proximity recognition is possible. The touch panel 1952 may further include a tactile layer. In this case, the touch panel 1952 may provide a user with a tactile reaction.

The (digital) pen sensor 1954 may be implemented, for example, using a method identical or similar to a method of receiving a touch input of a user, or using a separate recognition sheet. The key 1956 may include, for example, a physical button, an optical key, or a keypad. The ultrasonic input unit 1958 may identify data by detecting an acoustic wave with a microphone (for example, microphone 1988) of the electronic device 1900 through an input unit for generating an ultrasonic signal, and may perform wireless recognition. According to an embodiment, the electronic device 1900 may also receive a user input from an external device (e.g., a computer or server) connected thereto using the communication module 1920.

The display 1960 (for example, the display 250) may include a panel 1962, a hologram device 1964 or a projector 1966. For example, the panel 1962 may be, for example, a Liquid Crystal Display (LCD), an Active Matrix Organic Light Emitting Diode (AM-OLED), or the like. The panel 1962 may be implemented to be, for example, flexible, transparent, or wearable. The panel 1962 may be formed to be a single module with the touch panel 1952. The hologram 1964 may show a three dimensional image in the air by using an interference of light. The projector 1966 may display an image by projecting light onto a screen. The screen may be located, for example, inside or outside the electronic device 1900. According to an embodiment, the display 1960 may further include a control circuit for controlling the panel 1962, the hologram device 1964, or the projector 1966.

The interface 1970 may include, for example, a High-Definition Multimedia Interface (HDMI) 1972, a Universal Serial Bus (USB) 1974, an optical interface 1976, or a D-subminiature (D-sub) 1978. Additionally or alternatively, the interface 1970 may, for example, include a mobile high-definition link (MHL) interface, a secure digital (SD) card/multi-media card (MMC) interface, or an infrared data association (IrDA) interface.

The audio module 1980 may bidirectionally convert a sound and an electrical signal. The audio module 1980 may process sound information which is input or output through, for example, a speaker 1982, a receiver 1984, earphones 1986, the microphone 1988 or the like.

The camera module 1991 is a device for capturing still and moving images, and may include one or more image sensors (for example, a front sensor or a rear sensor), a lens (not illustrated), an image signal processor (ISP, not illustrated), or a flash (for example, an LED or a xenon lamp, not illustrated) according to an embodiment.

The power management module 1995 may manage power of the electronic device 1900. Although not illustrated, the power management module 1995 may include, for example, a Power Management Integrated Circuit (PMIC), a charger Integrated Circuit (IC), or a battery or fuel gauge.

The PMIC may be mounted within, for example, an integrated circuit or a SoC semiconductor. The charging methods may be classified into wired charging and wireless charging. The charger IC may charge a battery and may prevent an overvoltage or excess current from being induced or flowing from a charger. According to an embodiment, the charger IC may include a charger IC for at least one of the wired charging and the wireless charging. Examples of the wireless charging may include magnetic resonance charging, magnetic induction charging, and electromagnetic charging, and an additional circuit such as a coil loop, a resonance circuit, a rectifier or the like may be added for the wireless charging.

The battery gauge may measure, for example, a residual quantity of the battery 1996, and a voltage, a current, or a temperature during the charging. The battery 1996 may store or generate electricity and may supply power to the electronic device 1900 by using the stored or generated electricity. The battery 1996 may include, for example, a rechargeable battery or a solar battery.

The indicator 1997 may display a predetermined state of the electronic device 1900 or a part of the electronic device 1900 (for example, the AP 1910), such as a booting state, a message state, a charging state, or the like. The motor 1998 may convert an electrical signal into a mechanical vibration. Although not illustrated, the electronic device 1900 may include a processing unit (for example, a GPU) for supporting mobile TV. The processing unit for supporting mobile TV may process, for example, media data pursuant to a certain standard of Digital Multimedia Broadcasting (DMB), Digital Video Broadcasting (DVB), or media flow.

According to various embodiments of the present disclosure, it is possible to generate captured images for a virtual reality service by generating captured images through virtual reality images or binocular images corresponding to an image displayed on a display of the electronic device in a stereo display environment.

According to various embodiments of the present disclosure, it is possible to capture information related to a virtual reality environment by capturing images in a plurality of different directions based on a viewport displayed on the display of the electronic device in the stereo display environment.

A module or a programming module according to the present disclosure may include at least one of the described component elements, a few of the component elements may be omitted, or additional component elements may be included. Operations executed by a module, a programming module, or other component elements according to various embodiments of the present disclosure may be executed sequentially, in parallel, repeatedly, or in a heuristic manner. Further, some operations may be executed according to another order or may be omitted, or other operations may be added.

According to various embodiments, a computer readable recording medium having instructions stored therein may include a computer readable recording medium having a program recorded therein for executing an operation of identifying occurrence of an image display event through a display panel, an operation of identifying a location where an image is to be displayed, and an operation of controlling the focus of the location, where the image is to be displayed, through a focus control layer.

A module or programming module according to various embodiments of the present disclosure may include one or more of the above-described elements, may omit some elements, or may further include additional elements. The operations performed by the module, the programming module, or the other elements according to various embodiments of the present disclosure may be performed serially, in parallel, repeatedly, or heuristically. In addition, some operation may be performed in different order or may omitted, and an additional operation may be added.

FIGS. 1-19 are provided as an example only. At least some of the steps discussed with respect to these figures can be performed concurrently, performed in a different order, and/or altogether omitted. It will be understood that the provision of the examples described herein, as well as clauses phrased as “such as,” “e.g.”, “including”, “in some aspects,” “in some implementations,” and the like should not be interpreted as limiting the claimed subject matter to the specific examples.

The above-described aspects of the present disclosure can be implemented in hardware, firmware or via the execution of software or computer code that can be stored in a recording medium such as a CD-ROM, a Digital Versatile Disc (DVD), a magnetic tape, a RAM, a floppy disk, a hard disk, or a magneto-optical disk or computer code downloaded over a network originally stored on a remote recording medium or a non-transitory machine-readable medium and to be stored on a local recording medium, so that the methods described herein can be rendered via such software that is stored on the recording medium using a general purpose computer, or a special processor or in programmable or dedicated hardware, such as an ASIC or FPGA. As would be understood in the art, the computer, the processor, microprocessor controller or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein. Any of the functions and steps provided in the Figures may be implemented in hardware, software or a combination of both and may be performed in whole or in part within the programmed instructions of a computer. No claim element herein is to be construed under the provisions of 35 U.S.C. 112, sixth paragraph, unless the element is expressly recited using the phrase “means for”.

While the present disclosure has been particularly shown and described with reference to the examples provided therein, it will be understood by those skilled in the art that various changes in form and details may be made therein without departing from the spirit and scope of the present disclosure as defined by the appended claims.

What is claimed is:

1. An electronic device comprising:
a display; and
at least one processor configured to:
generate a virtual reality image,
generate a right eye image and a left eye image based on the virtual reality image,
pre-distort the right eye image and the left eye image based on lens distortion,
control the display to display a stereo image by using the right eye image and the left eye image, and
in response to detecting a capture event while the stereo image is displayed, generate a captured image by using the virtual reality image.

2. The electronic device of claim 1, further comprising a memory,
wherein the processor is configured to select, from one or more virtual reality images stored in the memory, the virtual reality image corresponding to the stereo image that is displayed on the display.

3. The electronic device of claim 1, wherein the processor is configured to estimate an intermediate viewpoint between a user's eyes in response to the capture event,
wherein the captured image is generated based on the intermediate viewpoint.

4. The electronic device of claim 1, wherein the virtual reality image includes a two-dimensional image that is generated by re-configuring at least a portion of an original image in accordance with the virtual reality environment,
wherein the virtual reality environment is shaped as at least one of a sphere, a rectangle, a cylinder, and a semi-sphere.

5. The electronic device of claim 1, wherein:
the virtual reality image includes a three-dimensional virtual reality image that is generated by rendering at least a portion of an original image in accordance with the virtual reality environment,
wherein the virtual reality environment is shaped as at least one of a sphere, a rectangle, a cylinder, and a semi-sphere.

6. The electronic device of claim 1, wherein the right eye image and the left eye image correspond to a user's binocular viewpoint.

7. An electronic device comprising:
a display; and
at least one processor configured to:
generate a virtual reality image,
generate a right eye image and a left eye image based on the virtual reality image,
pre-distort the right eye image and the left eye image based on lens distortion,
control the display to display a stereo image by using the right eye image and left eye image, and
in response to detecting a capture event while the stereo image is displayed, generate a captured image by using at least one of the right eye image and the left eye image.

8. The electronic device of claim 7, wherein the stereo image is generated based on one of the left eye image and the right eye image.

9. The electronic device of claim 8, wherein the processor is configured to select one of the right eye image and the left eye image, for use in generating the captured image, based on an inter-pupil distance.

10. The electronic device of claim 7, wherein the captured image is generated by combining the right eye image and the left eye image.

11. An electronic device comprising:
a display configured to display a stereo image in a viewport within a virtual reality space; and
at least one processor configured to capture information related to one or more images corresponding to one or more directions based on the viewport within the virtual reality space in response to a capture input.

12. A method of an electronic device, the method comprising:
generating, by the electronic device, a virtual reality image;
generating a right eye image and a left eye image based on the virtual reality image;
pre-distorting the right eye image and the left eye image based on lens distortion;
displaying a stereo image by using the right eye image and left eye image; and
in response to detecting a capture event while the stereo image is displayed, generating a captured image by using the virtual reality image.

13. The method of claim 12, wherein generating of the virtual reality image comprises generating a two-dimensional virtual reality image by re-configuring at least a portion of an original image in accordance with the virtual reality environment,
wherein the virtual reality environment is shaped as at least one of a sphere, a rectangle, a cylinder, and a semi-sphere.

14. The method of claim 12, wherein generating of the virtual reality image comprises generating a three-dimensional virtual reality image by rendering at least a portion of an original image in accordance with the virtual reality environment,
wherein the virtual reality environment is shaped as at least one of a sphere, a rectangle, a cylinder, and a semi-sphere.

15. The method of claim 12, wherein generating the captured image comprises selecting, from one or more virtual reality images stored in a memory of the electronic device, the virtual reality image corresponding to the stereo image that is displayed on the display.

16. The method of claim 12, further comprising estimating an intermediate viewpoint between a user's eyes in response to the capture event, wherein the captured image is generated based on the intermediate viewpoint.

17. A method of an electronic device, the method comprising:
generating, by the electronic device, a virtual reality image;
generating a right image and a left image based on the virtual reality image;
pre-distorting the right eye image and the left eye image based on lens distortion;
displaying a stereo image by using the right eye image and left eye image; and
in response to detecting a capture event while the stereo image is displayed, generating a captured image by using at least one of the right eye image and the left eye image.

18. The method of claim 17, wherein the captured image is generated based on one of the right eye image and the left eye image.

19. The method of claim 17, wherein generating of the captured image comprises selecting of the right eye image and the left eye image based on an inter-pupil distance.

20. The method of claim 17, wherein the captured image is generated by combining the right eye image and the left eye image.
